(19) United States
(12) Patent Application Publication
(10) Pub. No.: US 2025/0235870 A1
(43) Pub. Date: Jul. 24, 2025

(54) REAGENT CARTRIDGE AND TEMPERATURE CONTROL SYSTEM

(71) Applicant: Encodia, Inc., San Diego, CA (US)

(72) Inventors: Hayley S. CHONG, San Diego, CA (US); Grant F. WARDEN, San Diego, CA (US)

(73) Assignee: Encodia, Inc., San Diego, CA (US)

(21) Appl. No.: 18/120,676

(22) Filed: Mar. 13, 2023

Related U.S. Application Data
(60) Provisional application No. 63/319,696, filed on Mar. 14, 2022.

(51) Int. Cl. B01L 3/00

(52) U.S. Cl. CPC B01L 3/527; B01L 2200/16; B01L 2300/1844

(57) ABSTRACT

The present disclosure relates to a reagent handling system configured to maintain reagents and/or samples within a desired temperature range. The reagent handling system comprises a temperature-controlled chamber that is created within the walls of the reagent cartridge by coupling the reagent cartridge with a temperature regulating device configured to cool or heat a fluid that is at least partially confined by internal surfaces of the temperature-controlled chamber. The temperature-controlled chamber is configured to maintain the cooled or heated fluid within the desired temperature range for a desired period of time. The reagent cartridge optionally includes two parts, a reagent tray and a carrier. The reagent tray may be configured in a variety of alternative formats to receive different combinations of sample tubes and/or reagent volumes. In some embodiments, the reagent handling system is used on an apparatus for testing and/or analyzing macromolecules, such as proteins and peptides, and the present disclosure also relates to a method and a kit for testing macromolecules.

### CROSS-REFERENCE TO RELATED APPLICATION

The present application claims priority to U.S. provisional patent application No. 63/319,696, filed on Mar. 14, 2022, the disclosure and content of which are incorporated herein by reference in their entireties for all purposes.

### TECHNICAL FIELD

Embodiments of the invention relate to reagent handling systems, instruments that include such systems, and, more specifically, to reagent and/or sample handling for macromolecule testing and/or analysis.

### BACKGROUND

Existing technologies for analyzing macromolecules such as proteins or peptides are limited in several ways. In some peptide or protein analyses, it is desirable to keep reagents and/or samples within a desired temperature range for a duration of the analysis. Such temperature control may be accomplished by placing a reagent cartridge in a temperature-controlled chamber or placing a conventional reagent cartridge on a temperature-controlled plate.

There remains a need for improved techniques relating to high-throughput testing or analysis of macromolecules (e.g., peptides or proteins), as well as effective and simple methods for keeping necessary reagents and/or samples within a desired temperature range while the analyses are ongoing. There also remains a need for a space-efficient, flexible and/or ergonomic manner of storing reagents at multiple different temperatures on an apparatus during testing or analysis, while allowing for flexibility in a reagent cartridge design. The present invention addresses these needs.

The aspects of the invention will be apparent upon reference to the following detailed description. To this end, various references are set forth herein which describe in more detail certain background information, methods, systems and/or kits, and are each hereby incorporated by reference in their entireties.

### BRIEF SUMMARY

The summary is not intended to be used to limit the scope of the claimed subject matter. Other features, details, utilities, and advantages of the claimed subject matter will be apparent from the detailed description including those aspects disclosed in the accompanying drawings and in the appended claims.

While some on-market instruments house a temperature-controlled chamber in which an entire reagent cartridge, plate, or other vessel is placed and maintained at a certain temperature, this invention is novel in that the temperature-controlled chamber is created within the walls of the reagent cartridge, which occupies a smaller footprint on the instrument. Because the temperature-controlled chamber is created within the walls of the reagent cartridge, there may also be multiple temperature-controlled chambers on a single reagent cartridge, allowing for reagents requiring different storage temperatures to be housed in a single reagent cartridge. This invention also enables multiple arrangements of reagent cartridge, plate, or other vessel to be compatible with a single instrument's temperature control mechanism. The described flexibility and ergonomic advantage of the disclosed reagent handling systems are particularly useful for instruments that carry out macromolecular testing or analysis. Various biological or chemical macromolecule testing require different volumes or configurations of reagents, and yet may be performed on the same instrument. For example, protein sequencing and analysis assays (such as, for example, ProteoCode™ protein analysis assay) typically require use of multiple reagents of vastly different volumes and storage conditions, and different sets of reagents may be utilized for particular types of protein sequencing and analysis. Thus, an instrument for macromolecule testing or analysis needs to accommodate a variety of reagents (different for different variants of the assay) maintained in different optimal temperature ranges for an extended period of time (such as during duration of protein sequencing and analysis, which may last from 1 h to 48 h).

A reagent cartridge disclosed herein provides such flexibility and ergonomic advantages, and comprises an interior volume configured to keep reagents and/or samples in a temperature-controlled environment. The reagent cartridge optionally includes two parts, a reagent tray and a carrier. The interior, temperature-controlled volume is defined by internal surfaces of the reagent cartridge, and does not exist until the reagent cartridge or the reagent tray (as a part of the reagent cartridge) is coupled to a temperature regulating (heating and/or cooling) device, such as a thermoelectric cooler. In preferred embodiments, both internal surfaces of the reagent cartridge and the temperature regulating device form boundaries of the temperature-controlled volume. In preferred embodiments, the temperature-controlled volume is filled with a gaseous fluid, such as air, which transmits energy between the temperature regulating device and reagents in the reagent cartridge. In some embodiments, the temperature regulating device further comprises a fan configured to circulate the gaseous fluid within the temperature-controlled volume. In preferred embodiments, reagent receptacles located within the reagent cartridge (or the reagent tray) are not in direct contact (i.e., via a mechanical connection) with a surface of the temperature regulating device that that faces the temperature-controlled volume and forms the boundary of the temperature-controlled volume. In preferred embodiments, there is a space of at least 1 mm, filled with the fluid (e.g., gaseous fluid, such as air), between the closed ends of the reagent receptacles and the surface of the temperature regulating device that faces the temperature-controlled volume and forms the boundary of the temperature-controlled volume.

The reagent tray may be configured in a variety of alternative formats to receive different combinations of sample tubes and/or reagent volumes. In some embodiments, the reagent tray is disposable and is made of recyclable plastic. The carrier is configured to mate with the temperature regulating device and/or with another part of an apparatus. Together, the reagent tray, the carrier and the temperature regulating device form a temperature-controlled volume in which a thermal transfer fluid (e.g., air) is circulated. In some embodiments, the reagent cartridge connected to the temperature regulating device forms a portable unit, which can be inserted into, or combined with, an apparatus, such as, for example, an apparatus for analyzing macromolecules, such as peptides. This portable unit includes the temperature-controlled volume, which confines the thermal fluid and provides improved heat transfer between the temperature regulating device and the reagents within the reagent cartridge (or within the reagent tray as a part of the reagent cartridge). As is disclosed further herein, the improved heat transfer is enabled by configuring the reagent tray and/or carrier to form the boundaries (e.g., walls) of the temperature-controlled volume.

In one embodiment, provided herein is a reagent handling system configured to maintain reagents within a desired temperature range, the reagent handling system comprising a temperature regulating device and a reagent cartridge configured to hold a plurality of reagents and configured to be attached to the temperature regulating device, wherein a temperature-controlled volume is formed upon attachment of the reagent cartridge to the temperature regulating device, and an interior surface of the reagent cartridge and a surface of the temperature regulating device form boundaries of the temperature-controlled volume contained within the reagent handling system; and wherein the temperature regulating device is configured to cool or heat a gaseous fluid that is at least partially confined within the temperature-controlled volume, and further configured to maintain the gaseous fluid confined in the temperature-controlled volume within the desired temperature range.

In yet another embodiment, provided herein is a method for testing macromolecules, the method comprising the steps of:
(a) placing a plurality of reagents in a reagent cartridge configured to hold the plurality of reagents;
(b) attaching the reagent cartridge to a temperature regulating device to form a temperature-controlled volume, wherein (i) an interior surface of the reagent cartridge and a surface of the temperature regulating device form boundaries of the temperature-controlled volume, and (ii) the temperature regulating device is configured to heat or cool a gaseous fluid that is at least partially contained within the temperature-controlled volume;
(c) powering the temperature regulating device to heat or cool the gaseous fluid within the temperature-controlled volume, thereby keeping reagents the plurality of reagents in the reagent cartridge within a desired temperature range; and
(d) testing macromolecules using reagents from the plurality of reagents, while the reagents are kept within the desired temperature range by the gaseous fluid for a desired period of time.

In yet another embodiment, provided herein is a kit for performing testing of macromolecules, the kit comprising:
(a) a plurality of reagents in a reagent tray configured to hold the plurality of reagents, wherein reagents of the plurality of reagents are configured for delivery to an apparatus for testing of macromolecules; and
(b) a carrier, wherein: i) the reagent tray is configured to be inserted into the carrier to form a reagent cartridge; ii) the reagent cartridge is configured to be attached to a temperature regulating device; iii) the reagent cartridge attached to the temperature regulating device form a temperature-controlled volume configured to at least partially confine a gaseous fluid, wherein an interior surface of the reagent cartridge and a surface of the temperature regulating device form boundaries of the temperature-controlled volume; and iv) the temperature regulating device is configured to cool or heat the gaseous fluid confined in the temperature-controlled volume, and further configured to maintain the gaseous fluid confined in the temperature-controlled volume within a desired temperature range.

In yet another embodiment, provided herein is an apparatus for automated treatment of a sample containing macromolecules, the apparatus comprises:
at least one non-planar reaction chamber with a volume equal to or less than about 20 ml, wherein the at least one reaction chamber is subjected to temperature control and configured for allowing fluid flow-through;
a reagent handling system comprising a reagent cartridge comprising a plurality of reagent receptacles for containing a plurality of reagents, wherein the reagent handling system is configured to maintain the plurality of reagents within a desired temperature range, wherein the reagent handling system further comprises a temperature regulating device attached to the reagent cartridge, wherein a temperature-controlled volume is formed upon attachment of the temperature regulating device to the reagent cartridge, and an interior surface of the reagent cartridge and a surface of the temperature regulating device form boundaries of the temperature-controlled volume contained within the reagent handling system; and wherein the temperature regulating device is configured to cool or heat a gaseous fluid that is at least partially confined within the temperature-controlled volume, and further configured to maintain the gaseous fluid confined in the temperature-controlled volume within the desired temperature range;
   a plurality of valves connected in a supply line; and
   a control unit to control delivery of reagents of the plurality of reagents to the at least one reaction chamber, wherein:
   the delivery of the reagents is individually addressable,
the reagent receptacles are fluidically connected to the at least one reaction chamber via the supply line, and temperature control of the at least one reaction chamber, temperature control of the temperature-controlled volume, positioning of valves of the plurality of valves, and/or delivery of the reagents to the at least one reaction chamber is automated and controlled by the control unit.

In some embodiments of the disclosed systems and methods, the desired temperature range is different from a temperature outside the reagent cartridge by at least 5° C., at least 10° C., at least 15° C., or at least 20° C.

In some embodiments of the disclosed systems and methods, the reagent cartridge comprises:
(i) a reagent tray configured to hold a plurality of reagents; and
(ii) a carrier, wherein the reagent tray and the carrier form the temperature-controlled volume configured to at least partially confine the gaseous fluid.

In some embodiments of the disclosed systems and methods, the reagent handling system comprises a temperature-controlled chamber that is created within the walls (surfaces) of the reagent cartridge by coupling (attaching) the reagent cartridge with a temperature regulating device configured to cool or heat a fluid that is at least partially confined by internal surfaces of the temperature-controlled chamber. Such temperature-controlled chamber corresponds to the temperature-controlled volume formed within the reagent cartridge by internal surfaces of the reagent cartridge, and is configured to maintain the cooled or heated fluid contained in the temperature-controlled chamber within the desired temperature range.

In some embodiments of the disclosed systems and methods, the reagents are kept within the desired temperature range for as long as the testing of macromolecules is performed.

In yet another embodiment, provided herein is a reagent cartridge comprising:
a reagent tray configured to hold a plurality of reagents; and
a carrier, wherein the reagent tray and the carrier form a temperature-controlled volume configured to at least partially confine the gaseous fluid, and the reagent cartridge is configured to be attached to a temperature regulating device configured to cool or heat the fluid present within the temperature-controlled volume.

The present disclosure also relates to an apparatus for preparing and/or treating macromolecules (e.g., peptides and proteins) for sequencing and/or other analysis in a high-throughput manner, for example, as disclosed in WO 2021/076648 A1, and in the U.S. application Ser. No. 17/769,321 filed on Apr. 14, 2022, incorporated herein be reference.

### BRIEF DESCRIPTION OF THE DRAWINGS

Non-limiting embodiments of the present invention will be described by way of example with reference to the accompanying figures, which are schematic and are not intended to be drawn to scale. For purposes of illustration, not every component is labeled in every figure, nor is every component of each embodiment of the invention shown where illustration is not necessary to allow those of ordinary skill in the art to understand the invention.

FIG. 1A illustrates an exemplary reagent tray 1 (isometric projection top view and isometric projection bottom view). The reagent tray 1 contains receptacles 5 for different vial types. The receptacles 5 contain cutouts 6 at the bottom, which allow the bottom of vials to be exposed to circulated temperature-regulated fluid (e.g., air).

FIG. 1B illustrates an exemplary carrier 2 (isometric projection top view and top view), which is configured to accommodate reagent trays 1 of certain dimensions (such as the reagent tray 1 shown in FIG. 1A). The insert for reagent tray 1 is shown (where reagent tray 1 is to be placed); the size of the reagent tray and corresponding insert may match the size of a microtiter plate. The exemplary carrier 2 contains receptacles 5, which accommodate vials with non-temperature-controlled reagents.

FIG. 1C illustrates an exemplary reagent cartridge 3 comprising an exemplary reagent tray 1 and an exemplary carrier 2. Reagent cartridge 3 is inserted into adaptor 4, which is a part of an apparatus. Reagent cartridge 3 insertion direction is shown.

FIG. 1D illustrates an exemplary fixation method of reagent cartridge 3 on an apparatus. Adaptor 4 which acts as a receiver of reagent cartridge 3 is shown via isometric projection top view and side view. Guide rails 7 are configured to orient and secure reagent cartridge 3 such that the reagent tray 1 is seated over the adaptor cavity 8. Adaptor cavity 8 houses the temperature regulating device that is responsible for heating or cooling fluid within a temperature-controlled volume (e.g., temperature regulating device 9).

FIG. 2A illustrates an exemplary reagent handling system 10 comprising reagent cartridge 3, adaptor 4 and temperature regulating device 9 (isometric projection top view, isometric projection bottom view and side view). In this embodiment, reagent cartridge 3 consists only of reagent tray 1 and does not include reagent carrier 2. Temperature regulating device 9 is fixed to adaptor 4 inside adaptor cavity 8. Reagent tray 1 is seated over adaptor cavity 8. The reagent tray 1 contains receptacles configured to accommodate vials with reagents or to accommodate reagents without vials. Adaptor 4 is a part of an apparatus.

FIG. 2B illustrates an exemplary reagent tray 1 (isometric projection top view, isometric projection bottom view and top view), which is a part of the reagent handling system 10 shown on FIG. 2A. Upon attachment to adaptor 4 and temperature regulating device 9, temperature-controlled volume is formed inside reagent tray 1, where cooled or heated fluid (e.g. air) is circulated.

FIG. 2C illustrates an exemplary adaptor 4 and temperature regulating device 9 (isometric projection top view, isometric projection bottom view and side view), which are parts of the reagent handling system 10 shown on FIG. 2A.

FIG. 2D illustrates exemplary alternative configurations of reagent tray 1 that are suitable to use with the reagent handling system 10 shown on FIG. 2A. The reagent trays as shown are configured to accommodate a variable number of wells or troughs, or to accommodate wells or troughs of different shapes and volumes. The reagent trays can accommodate reagents filled directly into wells or troughs, or reagents filled into individual vials that are placed into the reagent tray.

FIG. 2E illustrates an exemplary reagent handling system 10 comprising reagent cartridge 3, adaptor 4 and temperature regulating device 9 (isometric projection top view and side view). In this embodiment, reagent cartridge 3 is different from the reagent cartridge 3 shown in FIG. 2A in that it is configured to accommodate different vial types and provide two different desired vial temperature ranges: temperature-controlled (e.g., refrigerated, see 14) and non-regulated (see 15). Reagent cartridge 3 contains reagents held in the temperature-regulated temperature-controlled volume 14 that are chilled from below by forced convection when the temperature regulating device 9 is running, and also contains a non-regulated region 15 that holds reagents at ambient temperature. The reagent cartridge 3 is attached on top of the temperature regulating device 9.

FIG. 3A and FIG. 3B illustrate an exemplary configuration of reagent tray 1 configured to accommodate up to 12 individual vials that optionally contain reagents and/or samples. FIG. 3A shows reagent tray 1 with vials installed and FIG. 3B shows reagent tray 1 without vials.

FIG. 4A and FIG. 4B illustrate exemplary configurations of reagent tray 1 according to various embodiments of the invention. FIG. 4A shows reagent tray 1 holding reagents filled directly into wells in the reagent tray (holding reagents without vials). FIG. 4A shows reagent tray 1 is holding reagents in individual vials that are installed into the reagent tray. Receptacles 5 of both reagent trays are foil-sealed (barrier lids) to keep the reagents in the wells and vials to prevent spills, leaks, and contamination, until they are opened for use, for example, in protein or peptide analysis.

FIG. 5 illustrates an exemplary temperature regulating device 9, comprising a thermoelectric cooling device (TEC) 11 and two fans 12. The temperature regulating device 9 is configured to regulate the temperature of the fluid (e.g., air) within the temperature-controlled volume formed inside reagent cartridge 3.

FIG. 6 illustrates an exemplary configuration of temperature regulating device 9 as a part of reagent handling system 10. Temperature regulating device 9 comprises TEC 11, two fans 12 and two heat sinks 13, which form a TEC stack (left). On the right, the TEC stack is installed onto the adaptor 4.

FIG. 7 illustrates an exemplary workflow of an apparatus for performing a peptide analysis. Peptide samples to be analyzed can be handled in the same way as reagents used during the peptide analysis. Reagent cartridge 3 containing reagents and/or samples is connected to temperature regulating device 9 mounted on the apparatus and configured to heat or cool fluid within the temperature-controlled volume formed by the interior surface of the reagent cartridge 3. During the peptide analysis, reagents and/or samples in the reagent cartridge 3 are kept at the desired temperature(s). The reagents and/or samples are taken from the reagent cartridge 3 by an autosampler system and delivered to a reaction chamber loaded on the apparatus.

FIG. 8. An exemplary flow diagram for method of performing a peptide analysis, showing key steps of the method disclosed herein.

FIG. 9 illustrates an exemplary apparatus 100 for analyzing macromolecules (e.g., peptides). The system includes n number of channels for supplying reagents into the reaction chamber 105, each connected to controlled valves 102 which may be opened or closed for the delivery of various reagents via each of the channels from the reagent handling system 10 comprising the reagent tray 1 filled with the reagents. Reagents inside the reagent handling system 10 are maintained within a desired temperature range. The reagent handling system 10 is fluidically connected by n channels to a pump 103. Selected reagents can be delivered from the reagent handling system 10 to the reaction chamber 105 by opening of controlled valve(s) 102 through a series of fluidic connections 107. The exemplary apparatus 100 is depicted in a situation where the pump 103 aspirates one reagent. The reagent handling system 10 is not a part of the apparatus 100 (as indicated by a dotted line).

FIG. 10A and FIG. 10B illustrate exemplary reagent cartridge performance data collected over a 90 minute period of cooling (Example 1). FIG. 10A shows the TEC object temperature (cold side) and sink temperature (hot side), as well as the temperatures of three tubes in the reagent cartridge 3 over time. In FIG. 10A, Tube 1 is a 5 mL Eppendorf tube filled with 4 mL of deionized water, and Tubes 2 and 3 are 1.1 mL Micronic tubes filled with 800 μL of deionized water, that are placed into a reagent carrier 3 and loaded into a reagent handling system 10. Two horizontal dotted lines indicate the upper limit (USL) and the lower limit (LSL) for the temperature setting for a specific peptide analysis application. FIG. 10B shows the current and voltage of the TEC over the 90 min period of time in the same experiment.

FIG. 11A and FIG. 11B illustrate an exemplary reagent handling system 10 having a single reagent cartridge 3 comprising two temperature-controlled chambers. The reagent cartridge 3 shown in FIG. 11A has two internal temperature-controlled volumes 14, each with a set of receptacles 5. The reagent cartridge 3 is configured to mate with adapter 4 shown in FIG. 11B. In this embodiment, adapter 4 has two temperature regulating devices 9. FIG. 11B shows a cross-section (A-A′) of isometric projection top view of the reagent cartridge 3 attached to the adapter 4, where each temperature regulating device 9 heats or cools the fluid within one temperature-controlled volume 14 on the reagent cartridge.

FIG. 12 illustrates exemplary alternative configurations of the temperature regulating device 9 which utilizes refrigeration principles and comprises evaporator coils 16 and one fan 12.

FIG. 13 illustrates an exemplary reagent handling system 10 having a single reagent cartridge 3 comprising two temperature-controlled chambers (the same as FIG. 11A and FIG. 11B). A cross-section (A-A′) of isometric projection top view of the reagent cartridge 3 attached to the adapter 4 is shown, where temperature regulating device 9 heats or cools the fluid within temperature-controlled volume 14 on the reagent cartridge. Access openings 17 and closed ends 18 of reagent receptacles 5 are shown, which extend vertically downwardly into the temperature-controlled volume 14. There is a space 19 filled with the gaseous fluid between the closed end of any one of the reagent receptacles 5 and the surface of the temperature regulating device 9 that faces the temperature-controlled volume 14 and forms the boundary of the temperature-controlled volume 14.

FIG. 14A and FIG. 14B illustrate an exemplary reagent handling system 10 comprising reagent cartridge 3 (FIG. 14A) and temperature regulating device 9 (FIG. 14B), configured to be attached to the reagent cartridge 3 from a side. Temperature regulating device 9 comprises TEC 11. FIG. 14A shows an exemplary reagent pack assembly (with bottles and tubes already affixed into reagent receptacles 5).

### DETAILED DESCRIPTION

Unless defined otherwise, all technical and scientific terms used herein have the same meaning as is commonly understood by one of ordinary skill in the art to which the present disclosure belongs. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, the singular forms “a,” “an” and “the” include plural referents unless the context clearly dictates otherwise. Thus, for example, reference to “a peptide” includes one or more peptides, or mixtures of peptides. Also, and unless specifically stated or obvious from context, as used herein, the term “or” is understood to be inclusive and covers both “or” and “and”.

The term “about” as used herein refers to the usual error range for the respective value readily known to the skilled person in this technical field. Reference to “about” a value or parameter herein includes (and describes) embodiments that are directed to that value or parameter per se. For example, description referring to “about X” includes description of “X.

As used herein, the term “sample” refers to anything which may contain an analyte for which an analyte assay is desired. As used herein, a “sample” can be a solution, a suspension, a liquid, a powder, a paste, an aqueous material, a non-aqueous material, or any combination thereof. In some embodiments, the sample is a biological sample. A biological sample of the present disclosure encompasses a sample in the form of a solution, a suspension, a liquid, a powder, a paste, an aqueous sample, or a non-aqueous sample. As used herein, a “biological sample” includes any sample obtained from a living or viral (or prion) source or other source of macromolecules and biomolecules, and includes any cell type or tissue of a subject from which nucleic acid, protein and/or other macromolecule can be obtained. The biological sample can be a sample obtained directly from a biological source or a sample that is processed. For example, isolated nucleic acids that are amplified constitute a biological sample. Biological samples include, but are not limited to, body fluids, such as blood, plasma, serum, cerebrospinal fluid, synovial fluid, urine and sweat, tissue and organ samples from animals and plants and processed samples derived therefrom. In some embodiments, the sample can be derived from a tissue or a body fluid, for example, a connective, epithelium, muscle or nerve tissue; a tissue selected from the group consisting of brain, lung, liver, spleen, bone marrow, thymus, heart, lymph, blood, bone, cartilage, pancreas, kidney, gall bladder, stomach, intestine, testis, ovary, uterus, rectum, nervous system, gland, and internal blood vessels; or a body fluid selected from the group consisting of blood, urine, saliva, bone marrow, sperm, an ascitic fluid, and subfractions thereof, e.g., serum or plasma.

The terms “level” or “levels” are used to refer to the presence and/or amount of a target, e.g., a substance or an organism that is part of the etiology of a disease or disorder, and can be determined qualitatively or quantitatively. A “qualitative” change in the target level refers to the appearance or disappearance of a target that is not detectable or is present in samples obtained from normal controls. A “quantitative” change in the levels of one or more targets refers to a measurable increase or decrease in the target levels when compared to a healthy control.

As used herein, the term “macromolecule” encompasses large molecules composed of smaller subunits. Examples of macromolecules include, but are not limited to peptides, polypeptides, proteins, nucleic acids, carbohydrates, lipids, macrocycles. A macromolecule also includes a chimeric macromolecule composed of a combination of two or more types of macromolecules, covalently linked together (e.g., a peptide linked to a nucleic acid). A macromolecule may also include a “macromolecule assembly”, which is composed of non-covalent complexes of two or more macromolecules. A macromolecule assembly may be composed of the same type of macromolecule (e.g., protein-protein) or of two more different types of macromolecules (e.g., protein-DNA).

Herein, the term “peptide” is used interchangeably with the term “polypeptide” encompasses peptides and proteins, and refers to a molecule comprising a chain of two or more amino acids joined by peptide bonds. In some embodiments, a polypeptide comprises 2 to 50 amino acids. In some embodiments, a peptide does not comprise a secondary, tertiary, or higher structure. In some embodiments, the polypeptide is a protein. In some embodiments, a protein comprises 50 or more amino acids. In some embodiments, in addition to a primary structure, a protein comprises a secondary, tertiary, or higher structure. Polypeptides may be naturally occurring, synthetically produced, or recombinantly expressed.

As used herein, the term “amino acid” refers to an organic compound comprising an amine group, a carboxylic acid group, and a side-chain specific to each amino acid, which serve as a monomeric subunit of a peptide. An amino acid includes the 20 standard, naturally occurring or canonical amino acids as well as non-standard amino acids. The standard, naturally-occurring (or natural) amino acids include Alanine (A or Ala), Cysteine (C or Cys), Aspartic Acid (D or Asp), Glutamic Acid (E or Glu), Phenylalanine (F or Phe), Glycine (G or Gly), Histidine (H or His), Isoleucine (I or Ile), Lysine (K or Lys), Leucine (L or Leu), Methionine (M or Met), Asparagine (N or Asn), Proline (P or Pro), Glutamine (Q or Gln), Arginine (R or Arg), Serine (S or Ser), Threonine (T or Thr), Valine (V or Val), Tryptophan (W or Trp), and Tyrosine (Y or Tyr).

The term “detectable label” as used herein refers to a substance which can indicate the presence of another substance when associated with it. The detectable label can be a substance that is linked to or incorporated into the substance to be detected. In some embodiments, a detectable label is suitable for allowing for detection and also quantification, for example, a detectable label that emits a detectable and measurable signal. Examples of detectable labels include a dye, a fluorophore, a chromophore, a fluorescent nanoparticle (e.g. quantum dot), a radiolabel, an enzyme (e.g. alkaline phosphatase, luciferase or horseradish peroxidase), or a chemiluminescent or bioluminescent molecule.

As used herein, the term “binding agent” refers to a nucleic acid molecule, a peptide, a polypeptide, a protein, carbohydrate, or a small molecule that binds to, associates, unites with, recognizes, or combines with a binding target, e.g., a polypeptide or a component or feature of a polypeptide. A binding agent may form a covalent association or non-covalent association with the polypeptide or component or feature of a polypeptide. A binding agent may be a naturally occurring, synthetically produced, or recombinantly expressed molecule. A binding agent may bind to a linear molecule or a molecule having a three-dimensional structure (also referred to as conformation). A binding agent may bind to an N-terminal amino acid, C-terminal amino acid, or an intervening amino acid of a peptide molecule. A binding agent may preferably bind to a chemically modified or labeled amino acid (e.g., an amino acid that has been labeled by a chemical reagent) over a non-modified or unlabeled amino acid. A binding agent may comprise a coding tag, which may be joined to the binding agent by a linker.

As used herein, the term “coding tag” refers to a polynucleotide with any suitable length, e.g., a nucleic acid molecule of about 2 bases to about 100 bases, including any integer including 2 and 100 and in between, that comprises identifying information for its associated binding agent. In certain embodiments, a coding tag may further comprise a binding cycle specific spacer or barcode, a unique molecular identifier, a universal priming site, or any combination thereof.

As used herein, the term “primer extension”, also referred to as “polymerase extension”, refers to a reaction catalyzed by a nucleic acid polymerase (e.g., DNA polymerase) whereby a nucleic acid molecule (e.g., oligonucleotide primer, spacer sequence) that anneals to a complementary strand is extended by the polymerase, using the complementary strand as template.

As used herein, the term “solid support” or “solid substrate” refers to any solid material, including porous and non-porous materials, to which a polypeptide can be associated directly or indirectly, by any means known in the art, including covalent and non-covalent interactions, or any combination thereof. A solid support may be two-dimensional (e.g., planar surface) or three-dimensional (e.g., gel matrix or bead). A solid support can be any support surface including, but not limited to, a bead, a microbead, an array, a glass surface, a silicon surface, a plastic surface, a membrane, a polymer matrix, a nanoparticle, or a microsphere. Materials for a solid support include but are not limited to acrylamide, agarose, cellulose, dextran, nitrocellulose, glass, gold, quartz, polystyrene, polyethylene vinyl acetate, polypropylene, polyester, polymethacrylate, polyacrylate, polyethylene, polyethylene oxide, polysilicates, polycarbonates, poly vinyl alcohol (PVA), Teflon, fluorocarbons, nylon, silicon rubber, polyanhydrides, polyglycolic acid, polyvinylchloride, polylactic acid, polyorthoesters, functionalized silane, polypropylfumerate, collagen, glycosaminoglycans, polyamino acids, dextran, or any combination thereof. A solid support, such as bead, may be porous. A bead's size may range from nanometers, e.g., 100 nm, to millimeters, e.g., 1 mm. In certain embodiments, beads range in size from about 0.2 micron to about 200 microns, or from about 0.5 micron to about 5 micron.

As used herein, “nucleic acid sequencing” means the determination of the order of nucleotides in a nucleic acid molecule or a sample of nucleic acid molecules. Similarly, “polypeptide sequencing” means the determination of the identity and order of at least a portion of amino acids in the polypeptide molecule or in a sample of polypeptide molecules. As used herein, “next generation sequencing” refers to high-throughput sequencing methods that allow the sequencing of millions to billions of molecules in parallel. Examples of next generation sequencing methods include sequencing by synthesis, sequencing by ligation, sequencing by hybridization, polony sequencing, ion semiconductor sequencing, and pyrosequencing.

As used herein, “analyzing” the polypeptide means to identify, detect, quantify, characterize, distinguish, or a combination thereof, all or a portion of the components of the polypeptide. For example, analyzing a peptide, polypeptide, or protein includes determining all or a portion of the amino acid sequence (contiguous or non-continuous) of the peptide. Analyzing a polypeptide also includes partial identification of a component of the polypeptide. For example, partial identification of amino acids in the polypeptide protein sequence can identify an amino acid in the protein as belonging to a subset of possible amino acids. Analyzing the peptide may include combining different types of analysis, for example obtaining epitope information, amino acid sequence information, post-translational modification information, or any combination thereof.

It is understood that aspects and embodiments of the invention described herein include “consisting of” and/or “consisting essentially of” aspects and embodiments.

Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range.

Provided herein is a reagent handling system 10 configured to maintain reagents within a desired temperature range, the reagent handling system 10 comprising: a reagent cartridge configured to hold a plurality of reagents and comprising a temperature-controlled volume formed within the reagent cartridge by surfaces of the reagent cartridge; and a temperature regulating device configured to cool or heat a fluid that is at least partially contained within the temperature-controlled volume, and further configured to maintain the fluid contained in the temperature-controlled volume within the desired temperature range.

Provided herein is also a reagent handling system 10 configured to maintain reagents within a desired temperature range, the reagent handling system comprising a temperature regulating device 9 and a reagent cartridge 3 configured to hold a plurality of reagents and configured to be attached to the temperature regulating device, wherein a temperature-controlled volume 14 is formed upon attachment of the reagent cartridge to the temperature regulating device, and an interior surface of the reagent cartridge and a surface of the temperature regulating device form boundaries of the temperature-controlled volume contained within the reagent handling system; and wherein the temperature regulating device is configured to cool or heat a gaseous fluid that is at least partially confined within the temperature-controlled volume, and further configured to maintain the gaseous fluid confined in the temperature-controlled volume within the desired temperature range.

Provided herein is also a method for testing macromolecules, the method comprising the steps of: (a) placing a plurality of reagents in a reagent cartridge configured to hold the plurality of reagents; (b) attaching the reagent cartridge to a temperature regulating device to form a temperature-controlled volume, wherein (i) an interior surface of the reagent cartridge and a surface of the temperature regulating device form boundaries of the temperature-controlled volume, and (ii) the temperature regulating device is configured to heat or cool a gaseous fluid that is at least partially contained within the temperature-controlled volume; (c) powering the temperature regulating device to heat or cool the gaseous fluid within the temperature-controlled volume, thereby keeping reagents the plurality of reagents in the reagent cartridge within a desired temperature range; and (d) testing macromolecules using reagents from the plurality of reagents, while the reagents are kept within the desired temperature range by the gaseous fluid for a desired period of time.

Provided herein is also a kit for performing testing of macromolecules, the kit comprising:
(a) a plurality of reagents in a reagent tray configured to hold the plurality of reagents, wherein reagents of the plurality of reagents are configured for delivery to an apparatus for testing of macromolecules; and
(b) a carrier, wherein: i) the reagent tray is configured to be inserted into the carrier to form a reagent cartridge; ii) the reagent cartridge is configured to be attached to a temperature regulating device; iii) the reagent cartridge attached to the temperature regulating device form a temperature-controlled volume configured to at least partially confine a gaseous fluid, wherein an interior surface of the reagent cartridge and a surface of the temperature regulating device form boundaries of the temperature-controlled volume; and iv) the temperature regulating device is configured to cool or heat the gaseous fluid confined in the temperature-controlled volume, and further configured to maintain the gaseous fluid confined in the temperature-controlled volume within a desired temperature range.

Provided herein is also an apparatus for automated treatment of a sample containing macromolecules, which apparatus comprises:
at least one non-planar reaction chamber with a volume equal to or less than about 20 ml, wherein the at least one reaction chamber is subjected to temperature control and configured for allowing fluid flow-through;
a reagent handling system comprising a reagent cartridge comprising a plurality of reagent receptacles for containing a plurality of reagents, wherein the reagent handling system is configured to maintain the plurality of reagents within a desired temperature range, wherein the reagent handling system further comprises a temperature regulating device attached to the reagent cartridge, wherein a temperature-controlled volume is formed upon attachment of the temperature regulating device to the reagent cartridge, and an interior surface of the reagent cartridge and a surface of the temperature regulating device form boundaries of the temperature-controlled volume contained within the reagent handling system; and wherein the temperature regulating device is configured to cool or heat a gaseous fluid that is at least partially confined within the temperature-controlled volume, and further configured to maintain the gaseous fluid confined in the temperature-controlled volume within the desired temperature range;
a plurality of valves connected in a supply line having an upstream end and a downstream end; and
a control unit to control delivery of reagents of the plurality of reagents to the at least one reaction chamber, wherein:
delivery of the reagents is individually addressable,
the supply line connects the reagent receptacles to the at least one reaction chamber and the reagent receptacles are fluidically connected to the at least one reaction chamber, and temperature control of the at least one reaction chamber, temperature control of the temperature-controlled volume, positioning of valves of the plurality of valves, and/or delivery of the reagents to the at least one reaction chamber is automated and controlled by the control unit.

Various embodiments of the reagent handling system equally apply to the method for testing macromolecules provided herein, to the kit for performing testing of macromolecules, and for the apparatus for automated treatment of a sample containing macromolecules but will for the sake of brevity be recited only once. Thus, various of the following embodiments apply equally to the method, kit and apparatus recited above.

In preferred embodiments, the reagent cartridge is configured to be attached to the temperature regulating device configured to cool or heat the fluid. In some embodiments, the reagent cartridge is configured to be attached to the temperature regulating device via an adaptor.

In some embodiments, the reagent cartridge comprises: (i) a reagent tray configured to hold a plurality of reagents; and (ii) a carrier, wherein the reagent tray and the carrier form the temperature-controlled volume configured to at least partially confine the fluid.

In some embodiments, the disclosed reagent handling system 10 is configured to handle samples to be analyzed in addition to reagents for analysis, such as it is configured to maintain samples within a desired temperature range. Samples to be analyzed can be handled in the same way as reagents used during the analysis. Therefore, in multiple embodiments of the invention described herein, term “reagent” includes both reagents for analysis and samples to be analyzed.

In preferred embodiments, the reagent tray comprises receptacles, which are protrusions extended downwardly into the interior space of the reagent tray (into the temperature-controlled volume) and configured to accommodate vials with reagents or reagents without vials. In some embodiments, the interior space of the reagent tray constitutes the temperature-controlled volume where the cold/hot fluid (e.g., air) is circulated. In some embodiments, the temperature-controlled volume is formed by the interior space of the reagent tray and the interior space of the carrier. In some embodiments, internal surfaces of both the reagent tray and the carrier form one or more temperature-controlled volume(s).

In some embodiments, surfaces of both the reagent tray and the carrier form the temperature-controlled volume.

In some embodiments, the reagent tray is one of a plurality of alternative reagent trays configured to be attached to the carrier to form the temperature-controlled volume.

In some embodiments, the reagent tray is configured to accommodate reagents filled directly into the receptacles that extend into the temperature-controlled volume.

In some embodiments, the reagent tray is configured to accommodate vials filled with the reagents, and the vials extend into the temperature-controlled volume.

In some embodiments, the reagent cartridge is configured to hold more than one type of reagent trays.

In some embodiments, at least two reagent trays of the plurality of alternative reagent trays have different arrangements of receptacles configured to accommodate vials including the reagents.

In some embodiments, the reagent cartridge is configured to be attached to the temperature regulating device via an adaptor.

In preferred embodiments, the temperature-controlled volume is not formed until the reagent cartridge is attached to the temperature regulating device.

In some embodiments, a top of the temperature-controlled volume is defined by the reagent tray and optionally sides of the temperature-controlled volume are defined by the carrier.

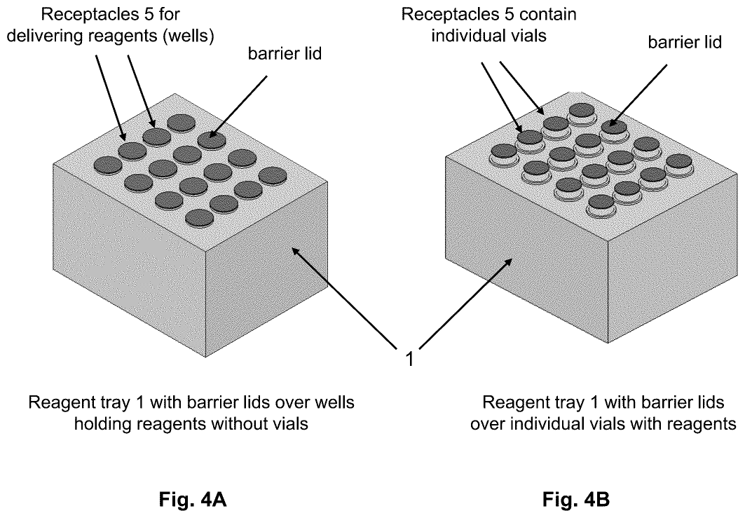

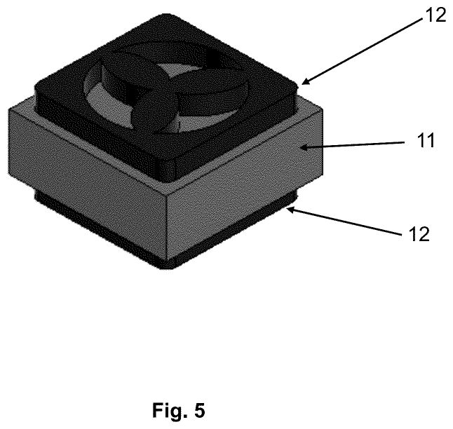

Various geometries of the receptacles can be utilized in the reagent tray 1, according to various embodiments of the invention. Different forms of protrusions (wells) that form the receptacles include, but not limited to, cylindrical, angled, open, closed; holding different volumes; holding reagents directly or holding vials; holding vials attached or holding vials dropped in. In some embodiments, the reagents are closed inside the receptacles by a membrane over all the receptacles (see e.g. FIG. 4A). Membrane types include but are not limited to septa, aluminum foil, plastic film such as polypropylene, or a combination thereof.

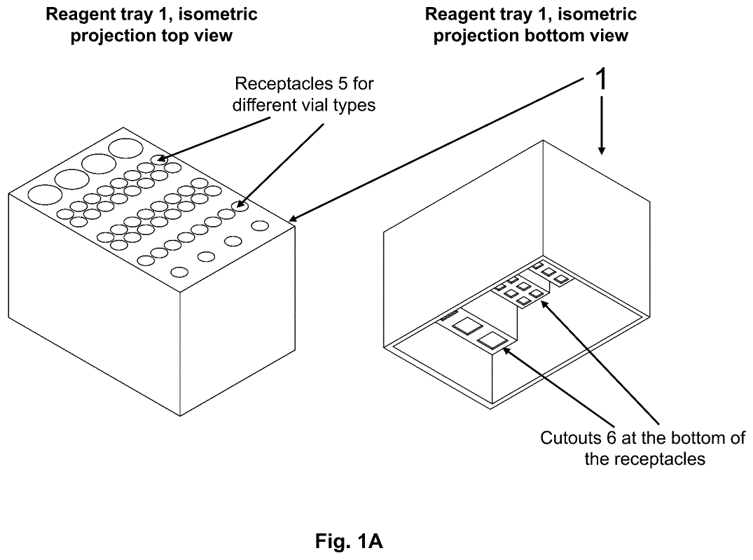

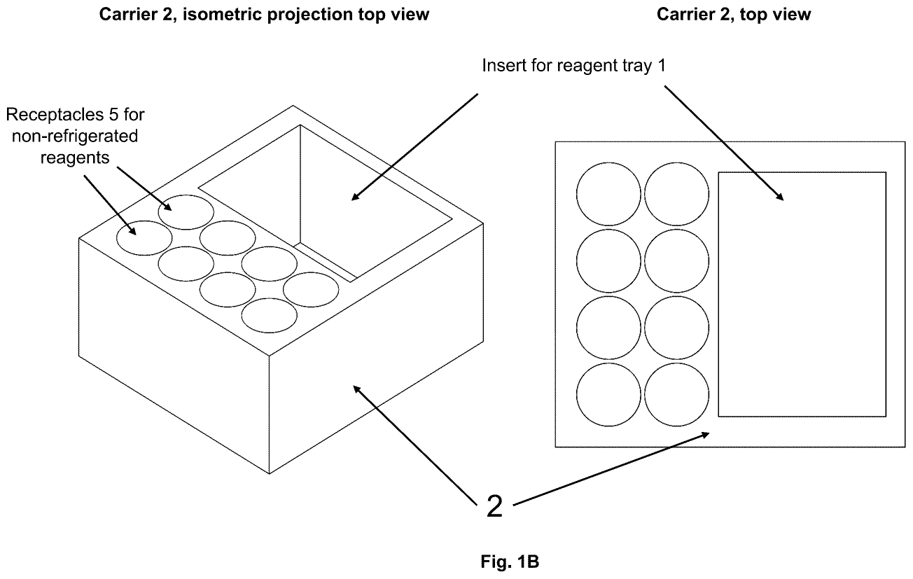

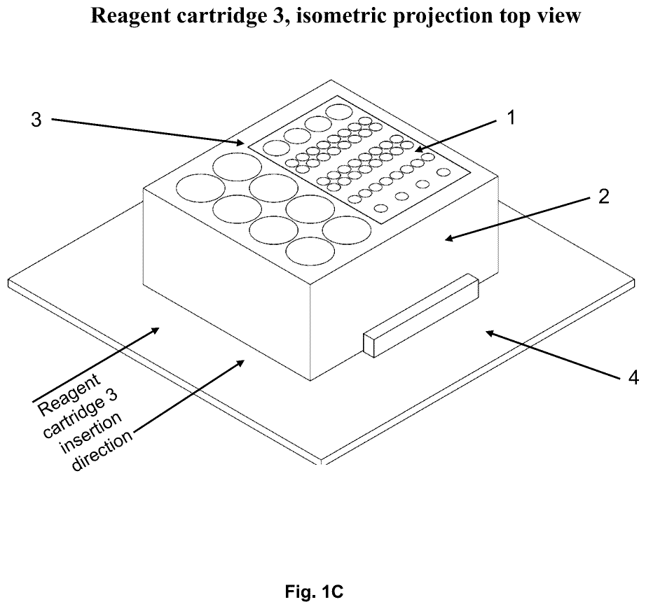

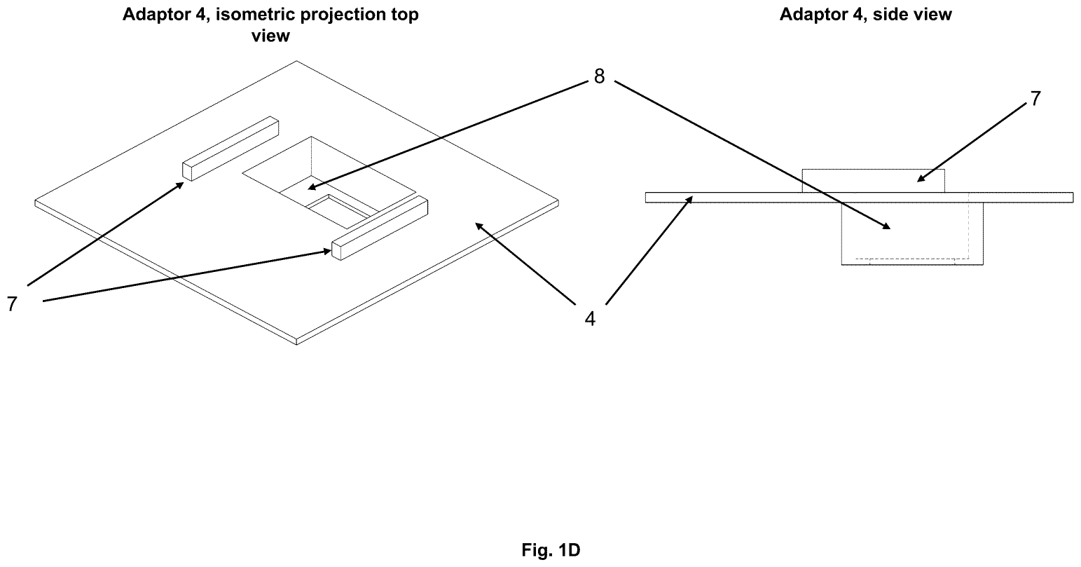

FIG. 1A-FIG. 1D show an exemplary reagent cartridge 3 containing reagent tray 1 and carrier 2, as well as an exemplary fixation method of reagent cartridge 3 via an adaptor 4 on an apparatus. The adaptor 4 acts as a receiver of reagent cartridge 3 and the guide rails 7 are configured to orient and secure reagent cartridge 3 during fixation.

Several features are specific to the configuration of the reagent cartridge 3 shown on FIG. 1A-FIG. 1D. First, the reagent tray 1 contains receptacles 5 configured to accommodate several types of vials simultaneously. Second, the receptacles 5 contain cutouts 6 at the bottom of the protrusions (e.g., wells) extended downwardly into the interior space of the reagent cartridge 3 (into the temperature-controlled volume), which allow bottom of vials to be directly exposed to circulated temperature-regulated fluid (e.g., air). Third, the carrier 2 also contains receptacles, which accommodate vials with non-temperature-controlled reagents.

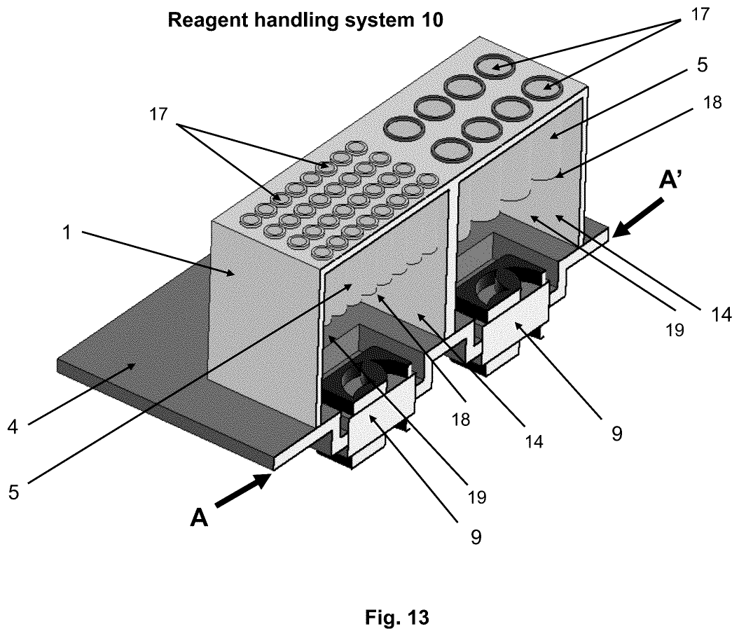

In some embodiments, receptacles 5 have cutouts 6 at the bottom of the protrusions, wherein cutouts 6 may be of different forms (cylindrical, squared, irregular, and so on). In other embodiments, receptacles 5 have access openings 17 and closed ends 18 (see FIG. 13).

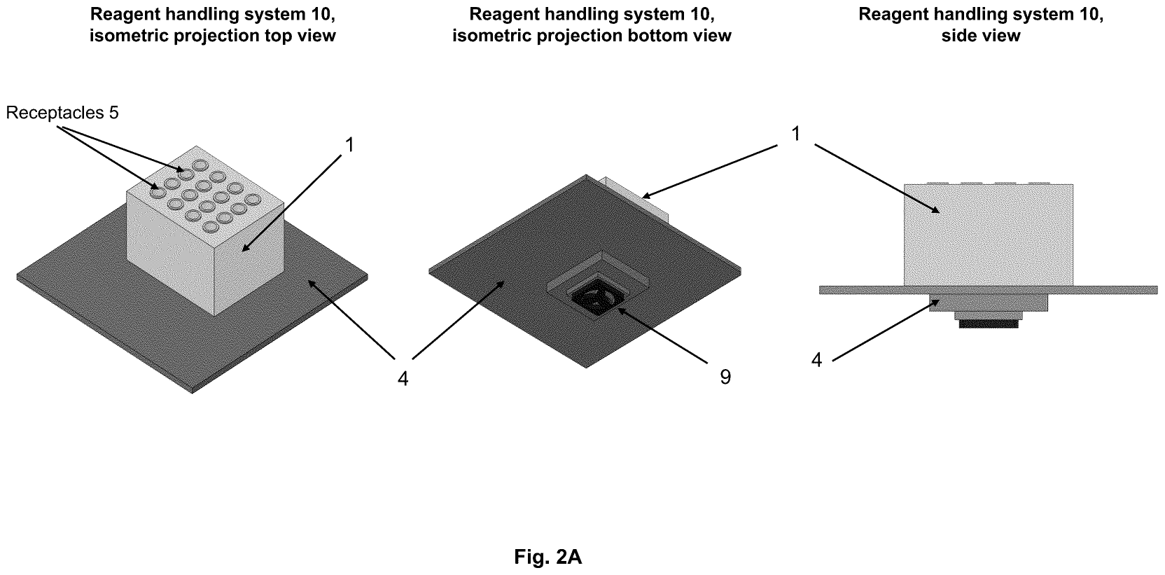

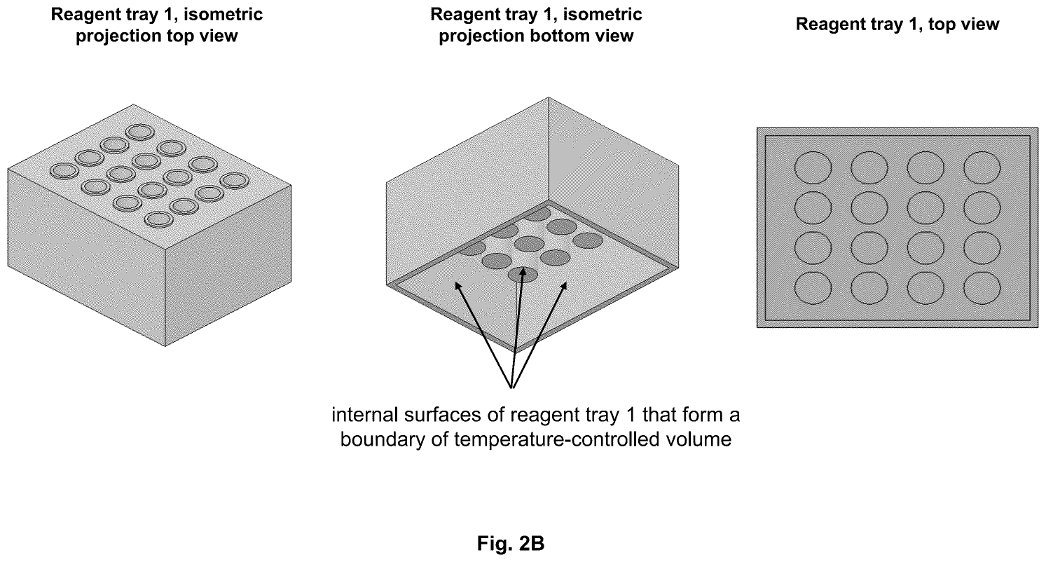

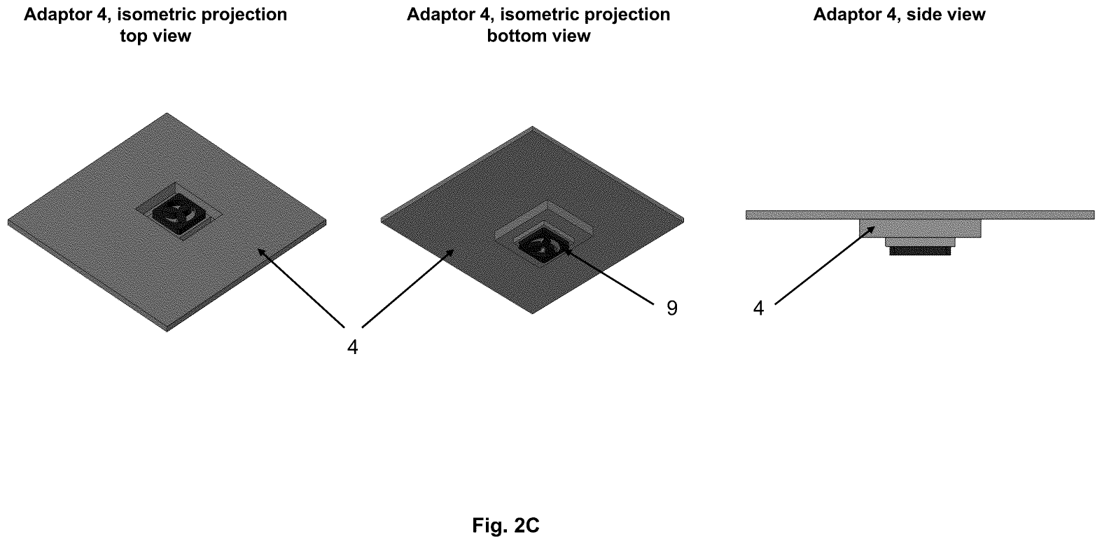

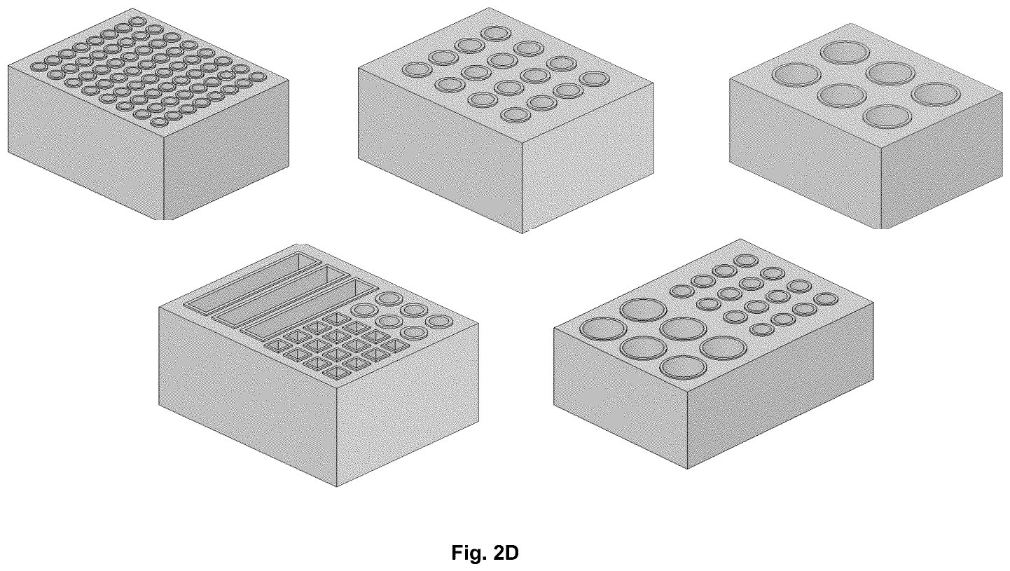

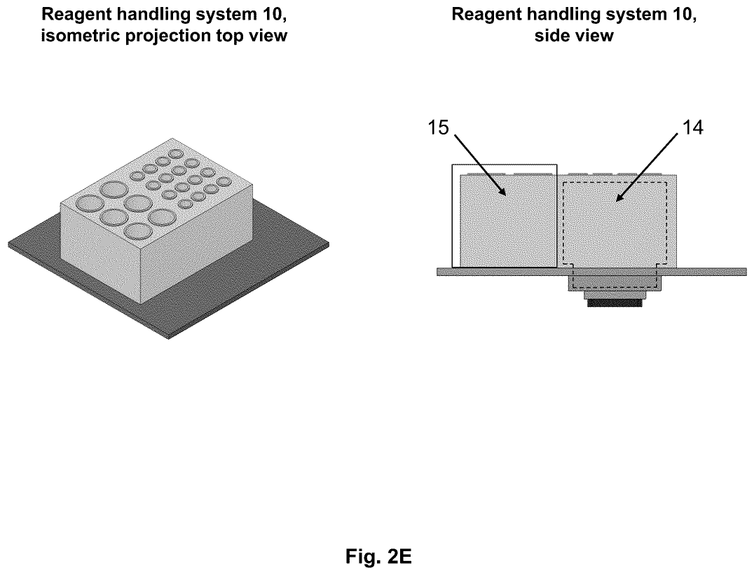

FIG. 2A-FIG. 2E show an exemplary reagent handling system 10 comprising reagent cartridge 3 (which contains reagent tray 1, but does not contain carrier 2), adaptor 4 and temperature regulating device 9. In these embodiments, reagent tray 1 is directly attached to the adaptor 4 mounted on an apparatus, and internal surfaces of the reagent tray 1 form the temperature-controlled volume for the temperature-controlled fluid (e.g. air).

In the embodiments of reagent cartridge 3 comprising carrier 2, carrier 2 is a component separate from an apparatus in which reagent cartridge 3 is configured to be used. Preferably, carrier 2 extends functionality of reagent tray 1, such as it holds (accommodates) vials with non-temperature-controlled reagents (see e.g. FIG. 1B).

In preferred embodiments, adaptor 4 is a part of the apparatus in which reagent cartridge 3 is configured to be used.

In preferred embodiments, the apparatus is an apparatus for analyzing proteins or peptides.

In some embodiments, the apparatus is an apparatus for treating peptides with chemical modifier agents configured to modify a terminal amino acid residue of a peptide molecule to generate a labeled terminal amino acid residue, as well as treating peptides with processing enzymes, such as modified dipeptidyl aminopeptidases configured to cleave labeled terminal amino acid residues from peptides. In some embodiments, the apparatus is used to carry out automated treatment of peptides. In some cases, the peptide analysis assay comprises nucleic acid encoding of molecular recognition events. In some cases, the provided apparatus and methods are for use in treating, preparing, modifying a peptide from a sample, such as biological sample for peptide sequencing and/or analysis that employs barcoding.

In preferred embodiments, depending on configuration of reagent cartridge 3 (with or without carrier 2), a top of the temperature-controlled volume of the cold/hot fluid is defined by the reagent tray 1 and sides of the temperature-controlled volume are defined by the reagent tray 1 and/or carrier 2. The bottom or a side of the temperature-controlled volume is typically defined by temperature regulating device 9. In some embodiments, carrier 2 may define four sides or three sides and bottom (in the case of a side mounted temperature regulating device 9) of the temperature-controlled volume. In some embodiments, a part of the internal space or surface of the reagent tray 1 is not exposed to the temperature-controlled volume.

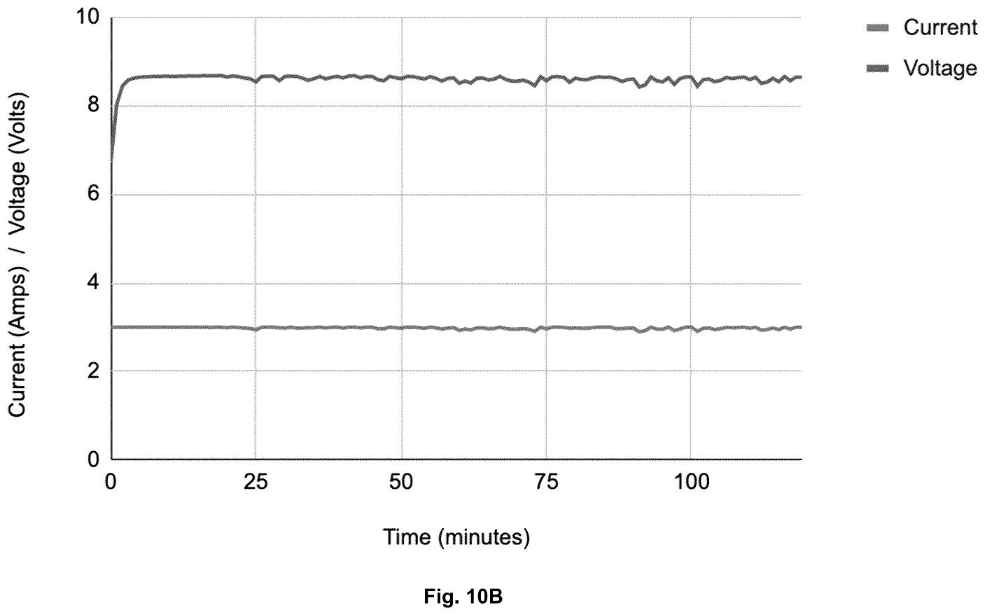

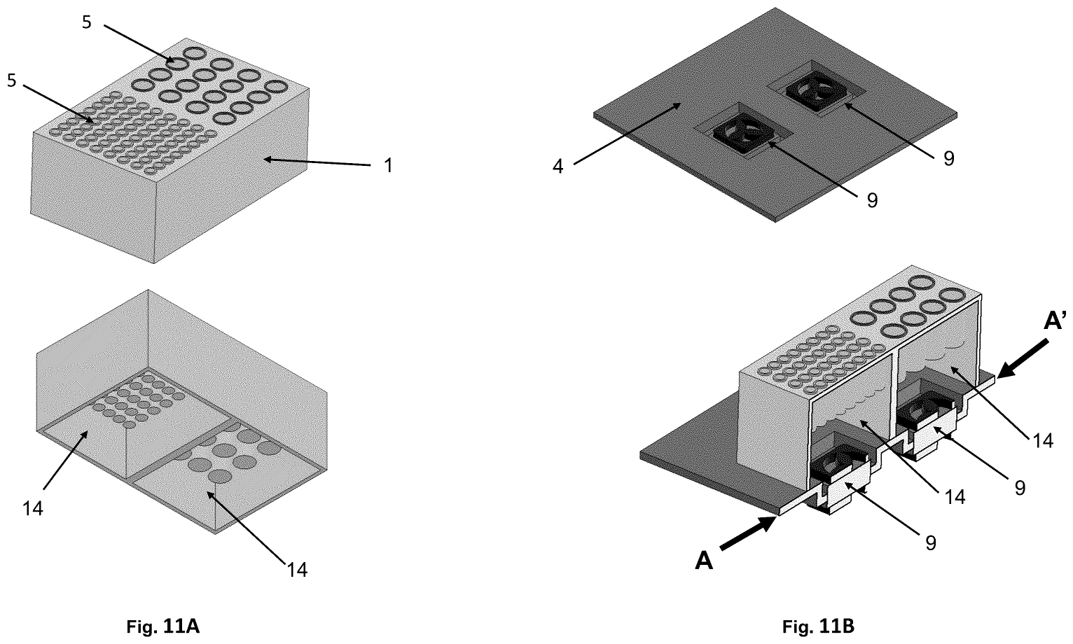

In some embodiments, the reagent tray 1 may be divided into two or more compartments having receptacles and wells configured to be exposed differently to the cold/hot fluid (e.g., atmospheric air or other gaseous fluid) generated by temperature regulating device 9 (see e.g. FIG. 11A and FIG. 11B). In some embodiments, two or more temperature-controlled volumes exist having different temperatures of the circulated fluid. In some embodiments, the two or more compartments of the reagent tray 1 are configured to maintain reagents within different temperature ranges. For example, one compartment of the reagent tray 1 is configured to maintain reagents within 0-5° C., and another compartment of the reagent tray 1 is configured to maintain reagents within 5-10° C. Other desired temperature intervals may be implemented. Different temperature ranges for different compartments of the reagent tray 1 may be achieved by a number of ways, for example, by specific geometry of the internal space of the reagent tray 1, where temperature regulating device 9 is located closer to the first compartment than to the second one, or where the second compartment is partially obstructed from the first compartment, so the second compartment is exposed to less amount of the cold/hot fluid (e.g. air). In another embodiment, material or structure (such as wall thickness) of the first compartment may be different from the second compartment. In yet another embodiment, two or more temperature regulating devices 9 may be used in the reagent handling system. An exemplary embodiment of the reagent handling system 3 comprising two independently temperature regulated chambers is shown in FIG. 11A-11B.

FIG. 11A and FIG. 11B illustrate an exemplary reagent handling system 10 that accommodates two temperature-controlled chambers. The reagent tray 1 installed on the adaptor 4 forms two separated temperature-controlled volumes configured to have two different temperatures. The reagent handling system also comprises two temperature regulating devices, each comprising a thermoelectric cooling device (TEC) 11 and a fan 12. Reagents held inside the two separate sections of the tray 1 are chilled independently from below by forced convection when the two temperature regulating devices 9 are running. This configuration may be expanded to include n separate chambers on the reagent cartridge forming n internal temperature-controlled volumes 14, so long as the adapter 4 is configured with the same quantity n of temperature regulating devices 9.

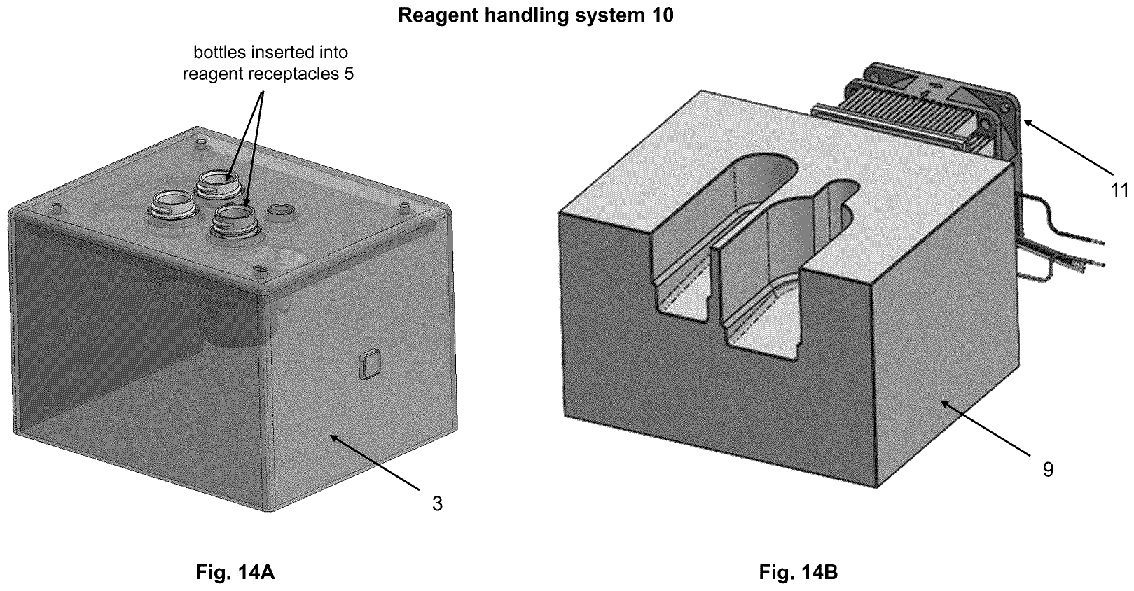

Exemplary reagent handling systems 10 are also shown in FIG. 13 and FIG. 14A-14B.

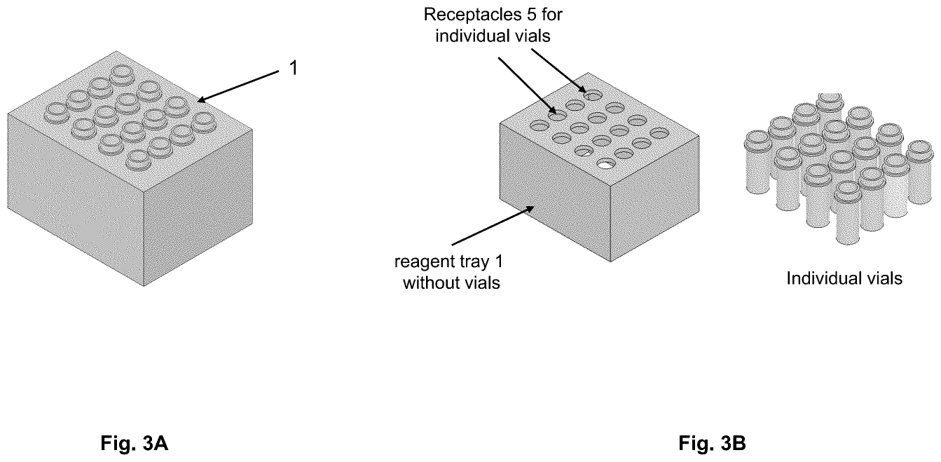

In preferred embodiments, the reagent cartridge 3 or the reagent tray 1 comprises a plurality of reagent receptacles to which reagents and/or samples can be placed and hold within the desired temperature range. In some embodiments, reagent receptacles are openings where vials with reagents and/or samples may be placed (see e.g., FIG. 3A-3B). In some embodiments, each reagent receptacle of plurality of reagent receptacles comprises an access opening and a closed end (see e.g., FIG. 13). In some embodiments, each reagent receptacle extends vertically downwardly into the temperature-controlled volume with an outer surface of the closed end 18 located within the temperature-controlled volume, which allows for efficient temperature control of a reagent within the reagent receptacle (see e.g., FIG. 13). Reagents and/or samples are placed towards closed ends of reagent receptacles, and are exposed to the environment (i.e., fluid at particular temperature) present in the temperature-controlled volume, which allows for the reagents and/or samples to stay within the desired temperature range for an extended period of time.

In preferred embodiments, closed ends 18 of the reagent receptacles 5 located within the reagent cartridge 3 or the reagent tray 1 are not in direct contact (i.e., via a mechanical connection) with a surface of the temperature regulating device that faces the temperature-controlled volume and forms a boundary of the temperature-controlled volume. In preferred embodiments, there is a space 19 (see FIG. 13) of at least 1 mm, at least 2 mm, at least 5 mm, at least 10 mm, at least 20 mm, at least 50 mm, at least 100 mm, or at least 200 mm, filled with the fluid (e.g., gaseous fluid, such as air), between the closed ends of the reagent receptacles and the surface of the temperature regulating device that forms a boundary of the temperature-controlled volume. In some embodiments, the space 19 is the closest distance between an end of reagent receptacle 5 closest to a surface of the temperature regulating device 9 (that faces the temperature-controlled volume 14 and forms a boundary of the temperature-controlled volume 14) and the surface of the temperature regulating device 9. In some embodiments, the space 19 can be measured from an end of reagent receptacle 5 closest to the surface of the temperature regulating device 9 (that faces the temperature-controlled volume 14 and forms a boundary of the temperature-controlled volume 14) and a site on the surface of the temperature regulating device 9 which is the closest to the end of the reagent receptacle(s) 5.

In preferred embodiments, the reagent cartridge does not have a bounded volume in which reagents are temperature-controlled until it is inserted into (or paired with) the temperature regulating device to form the reagent handling system. In some embodiments, the temperature-controlled volume is present only within the volume bounded by certain faces of the reagent cartridge and a portion of the temperature regulating device (and, optionally, with a portion of the apparatus to which the reagent handling system is connected). In some embodiments, when the reagent cartridge is not inserted, the temperature-controlled volume is not present, and therefore the apparatus does not have the capacity to control the temperature of the cavity in which the reagents would otherwise be stored.

In some embodiments, the reagent cartridge or the reagent tray comprises a plurality of reagent receptacles each comprising an access opening and a closed end, wherein each reagent receptacle extends vertically downwardly into the temperature-controlled volume. Accordingly, the plurality of reagent receptacles of the reagent cartridge or the reagent tray fills up a portion of the temperature-controlled volume of the reagent handling system. In some embodiments, the temperature-controlled volume of the reagent handling system is at least 5% greater, at least 10% greater, at least 20% greater, at least 30% greater, at least 50% greater, or at least 100% greater than the total volume of the plurality of reagent receptacles of the reagent cartridge or the reagent tray. In some embodiments, the temperature-controlled volume of the reagent handling system is no more than 2 times greater, no more than 3 times greater, no more than 5 times greater, or no more than 10 times greater than the total volume of the plurality of reagent receptacles of the reagent cartridge or the reagent tray.

In preferred embodiments, the temperature-controlled volume of the reagent handling system 10 is filled with a fluid.

In preferred embodiments, the cold/hot fluid used to maintain reagents within a desired temperature range is a gaseous fluid. In some preferred embodiments, the cold/hot fluid used to maintain reagents within a desired temperature range comprises air (i.e., atmospheric air). In other embodiments, the cold/hot fluid used to maintain reagents within a desired temperature range may comprise other types of gas or liquid, such as carbon dioxide, nitrogen, glycols, silicones, mineral oils, or other commonly used thermal transfer media. In some embodiments, demineralized water is used as the cold/hot fluid. In some embodiments, the fluid is a low-density thermal transfer fluid. In some embodiments, the density of the fluid is less than 10 kg/m³, less than 5 kg/m³, less than 2 kg/m³, or less than 1.5 kg/m³ at a temperature of 273 K and at a pressure of 101.325 kPa.

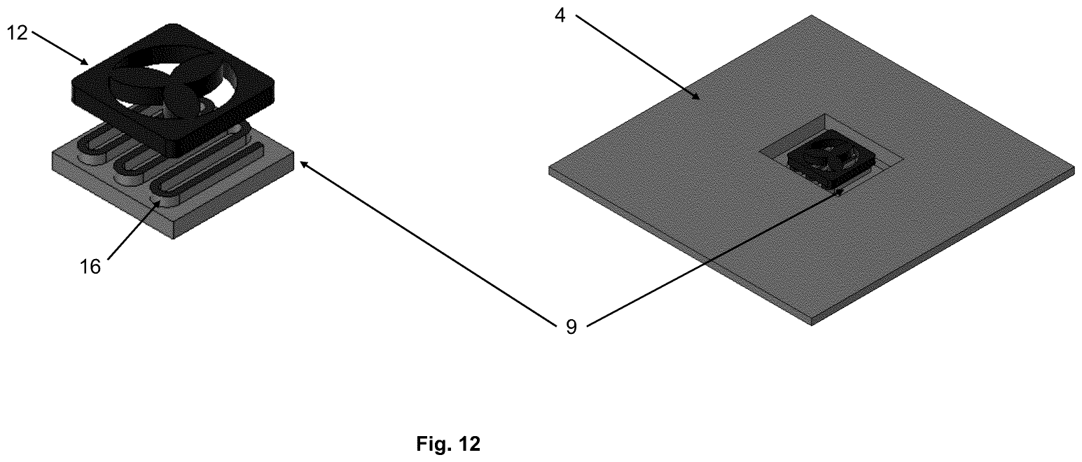

In some embodiments, refrigeration coils used in a standard refrigeration system can be used as temperature regulating device 9 in reagent handling system 10. FIG. 12 illustrates an exemplary adaptor 4 with evaporator coils which flow liquid refrigerant through and absorb heat from their surroundings (coils may be used as temperature regulating device 9—a cooling source). When a reagent cartridge 3 is installed, it creates an internal chamber (temperature-controlled volume) which will be cooling. Not shown on FIG. 12 are the compressor, the condenser coils, and the metering device.

In some embodiments, the temperature-controlled volume formed within the reagent cartridge 3 by surfaces of the reagent cartridge 3 and temperature regulating device 9 is air-tight or liquid-tight, depending on the type of cold/hot fluid used to maintain reagents within a desired temperature range. In preferred embodiments, the temperature-controlled volume(s) is/are not air-tight. Although air-tight (or liquid-tight) property of the temperature-controlled volume may increase efficiency of the cooling/heating process, it is not necessary for many applications, and may increase design complexity and production cost of the reagent handling system.

In some embodiments, reagent tray 1 is disposable, whereas carrier 2 is reusable (multi-use component). In some embodiments, reagent tray 1 is delivered to a user filled with reagents and sealed (see e.g., FIG. 4A); reagent tray 1 is discarded after use. In other embodiments, reagent tray 1 may be a multi-use component. Other combinations of single-use and multi-use reagent tray 1 and carrier 2 are possible.

Reagent tray 1 can made of polymeric composition, such as plastic. Preferably, reagent tray 1 is made of recyclable plastic. Non-limiting examples of polymeric compositions suitable for reagent tray 1 include polycarbonate or polyolefins, such as polypropylene and polyethylene. In certain embodiments, especially when the reagent tray 1 is exported to a cold environment, polymeric compositions include a blow moldable thermoplastic polyolefin/polypropylene blend, a thermoplastic elastomer/polypropylene blend interpenetrating polyolefin blend, a thermoplastic having a glass transition temperature less than −80° C./polyolefin blend, a heterogeneous polymer blend, and a thermoplastic having a glass transition temperature less than −20° C./polyolefin blend, a thermoplastic vulcanizate/polyolefin blend. In certain embodiments, heterogeneous polymer blends having a crystalline thermoplastic phase and a high molecular weight or crosslinked elastomeric phase may be supplied by Exxon Mobile or Advanced Elastomer Systems. In at least one embodiment, the ratio of thermoplastic polymer to polyolefin ranges from 5 wt. % to 70 wt. % of the blend. In another embodiment, the ratio of thermoplastic polymer to polyolefin ranges from 10 wt. % to 40 wt. %.

In some embodiments, temperature regulating device 9 comprises a thermoelectric cooler (TEC) 11 and at least one fan 12 (utilizing Peltier cooling). A number of thermoelectric coolers are known and can be used to generate the cold/hot fluid (e.g. air) in the temperature-controlled volume. Exemplary TEC devices are disclosed in the following US patents and patent applications: U.S. Pat. Nos. 4,581,898 A, 4,776,825 A, 6,097,088 A, 6,560,968 B2, US20100122540 A1, US20170179000 A1.

In some embodiments, the parameters of interest for thermoelectric cooler (TEC) 11 are Maximum Heat Load (Qmax) in Watts and Maximum Temperature Difference (ATmax) between hot and cold side in degrees Celsius (° C.). The parameter ATmax is given at a specific temperature of the hot side of the thermoelectric cooler, which may be written as ATmax (Th=50° C.). This means that the maximum temperature difference obtainable between the hot and cold side of the thermoelectric cooler is ATmax when the hot side is at T=50° C. In some preferred embodiments, specifications for thermoelectric cooler 11 are as follows:

Qmax>=30W;ΔTmax(Th=50° C.)>=70° C.

In some embodiments, temperature regulating device 9 comprises a thermoelectric cooler (TEC) 11 and two fans 12, both on the cold side and hot side. The parameters of interest for fans 12 are Speed (Rotations Per Minute [RPM]), Max Airflow (Cubic Feet per Minute [CFM]), and Max Static Pressure (Inches of H2O).

In some preferred embodiments, specifications for two fans 12 are as follows: cold side: speed >=3000 RPM; max airflow >=5 CFM; max static pressure >=0.10″ H2O; hot side: speed >=3000 RPM; max airflow >=20 CFM; max static pressure >=0.10″ H2O.

In some embodiments, the TEC 11 is connected to an electronic control board which is used to control the target temperature and the ramping behavior of the TEC. In some preferred embodiments, there is at least one temperature probe on the cold side and one on the hot side of the TEC which give feedback to the TEC control board. The overall apparatus/system software communicates with the TEC control board to set a target temperature and to give inputs around the desired behavior of the TEC. The ramp rates of the TEC control board can be controlled in multiple different ways. In some embodiments, the PID (proportional-integral-derivative) mechanism is employed by the TEC board which optimizes the speed at which the TEC ramps down to the target temperature and maintains the target temperature once reached. Other mechanisms can be implemented to supply the TEC with a constant voltage or constant current until the target temperature is detected by the cold side temperature probe.

In some embodiments, the reagent cartridge 3 is configured to be attached to the temperature regulating device 9 via an adaptor 4 (see e.g., FIG. 1A and FIG. 2A).

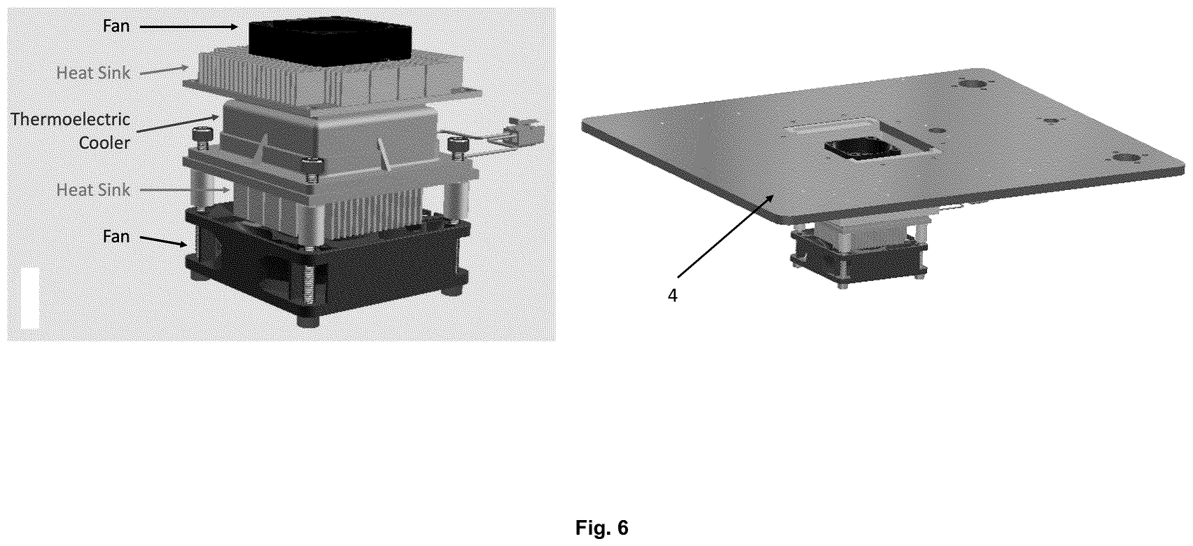

In some embodiments, the temperature regulating device 9 comprises a heatsink and a fan configured to circulate the fluid within the temperature-controlled volume, the fluid optionally comprising air. An exemplary temperature regulating device 9 comprising TEC 11, two fans 12 and two heat sinks 13 is shown in FIG. 6.

The bottom of the reagent cartridge 3 interfaces with the thermoelectric cooler (TEC) stack consisting of a Peltier module, two heat sinks, two fans, and an adapter (FIG. 6). The adapter is used to anchor the TEC stack to the apparatus, and forms the bottom of the cooled chamber. The adapter x- and y-dimensions match the footprint of the reagent cartridge 3. The TEC adapter 4 is mounted on the underside of the apparatus z-stage. The reagent cartridge is inserted by the user onto the top of the z-stage. The temperature-controlled volume is formed between the cold side of the TEC stack and the internal space of reagent cartridge 3 when the reagent cartridge 3 is positioned over the TEC stack.

When the TEC and fans are powered, the TEC cools the heat sink, and the fan circulates air across the heat sink and through the temperature-controlled volume, which cools the reagent tubes sitting in the reagent cartridge 3 by forced convection.

In some embodiments, the reagent cartridge 3 could also be heated through forced convection by reversing the current polarity through the TEC, creating an incubation chamber rather than a refrigerated chamber.

In some embodiments, instead of TEC, a conventional vapor-compression system can be used to cool or heat the fluid in the temperature-controlled volume (see e.g., FIG. 12). In other embodiments, the cold or hot fluid comprises a refrigerant, which is contained within walls of the reaction cartridge 3.

One of the advantages of the disclosed reagent handling system 10 is build-in flexibility in handling of a plurality of reagents and/or samples. This is particularly advantageous in the field of macromolecule (e.g., peptide) analysis, as varied sample preparation or analytical methods may be needed based on macromolecules (e.g., proteins or peptides) of interest which may be present in the sample, affecting the reagent types and volumes which may need to be handled by the reagent handling system. Often, during a macromolecule (e.g., peptide) analysis, reagents and/or samples need to be kept within a desired temperature range for an extended period time (e.g., 1-24 h). The disclosed reagent handling system may be placed into an apparatus, filled with the reagents and/or samples, and provide means for maintaining the reagents and/or samples within the desired temperature range.

Multiple configurations of reagent tube size, position, and quantity are compatible so long as the tubes fit into the x- and y-dimensions of the reagent cartridge 3. Consequently, this cooling/heating system can support multiple iterations of reagent cartridge 3 layouts without changing the instrument hardware. FIG. 1A, FIG. 1B and FIG. 2D illustrate examples of alternative reagent trays 1 and carriers 2, according to various embodiments of the invention. In preferred embodiments, the reagent tray 1 is one of a plurality of alternative reagent trays 1 configured to be attached to carrier 2 or adaptor 4 to form the temperature-controlled volume; and the reagent cartridge 3 is configured to hold more than one type of reagent tray 1. The disclosed reagent trays 1 have different patterns of receptacles 5 and are capable of accommodating a variety of different vials containing reagents. The vials can be either fixed in the reagent cartridge 3, or have a drop-in design (see e.g., FIGS. 3A and 3B). In some embodiments, instead of holding vials with reagents, receptacles 5 are configured to accommodate reagents without vials. In one example, configuration of receptacles 5 of the reagent cartridge 3 resembles a microtiter plate with wells configured to accommodate reagents and/or samples. In some embodiments, some of the receptacles 5 of the reagent cartridge 3 are within the temperature-controlled volume, while the other receptacles 5 are outside the temperature-controlled volume, and are used for non-refrigerated reagents. In some embodiments, some of the receptacles 5 of the reagent cartridge 3 are within the first temperature-controlled volume having a first temperature range, while the other receptacles 5 are within the second temperature-controlled volume having a second temperature range, different from the first temperature range (see e.g. FIG. 11A and FIG. 11B).

In preferred embodiments, the temperature regulating device forms a boundary of the temperature-controlled volume together with the internal surface of the reagent cartridge 3.

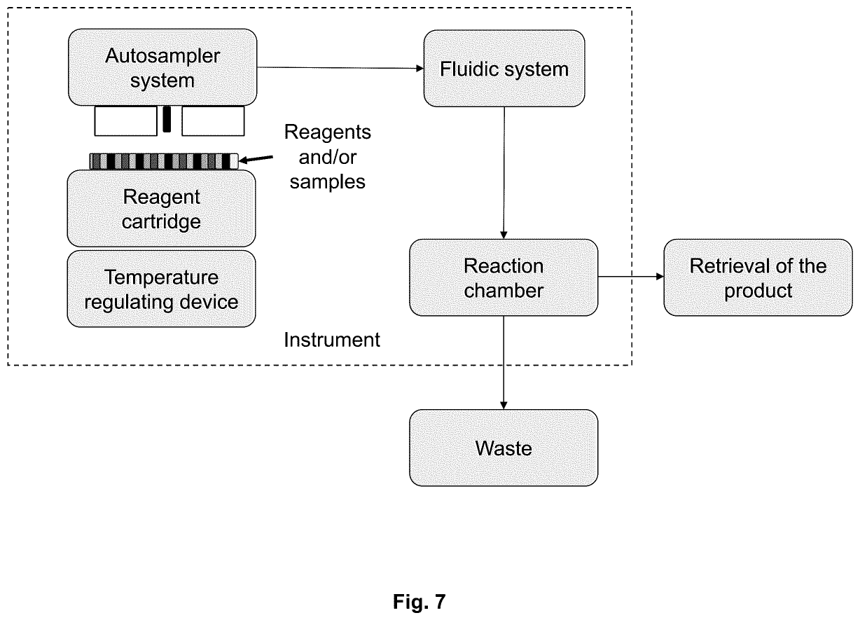

FIG. 7 illustrates a reagent handling system 10 comprising an adaptable reagent cartridge 3 attached to temperature regulating device 9 mounted on the apparatus via an adaptor 4 and coupled to an autosampler system, which is used to take selected reagents and/or samplers from the reagent cartridge 3 and deliver via fluidic system of the apparatus to the reaction chamber. Preferably, the autosampler system is mounted on 2-axis motorized precision positioning stage (X-Y translation stage). In preferred embodiments, the reagent cartridge 3 is coupled to X-Y translation stage and/or a sample manipulator located above the reagent tray 1, so that the heating or cooling of the reagents and/or samples occurs while the autosampler system or the sample manipulator is in use. In other embodiments, the robotic system surrounding the reagent cartridge may comprise a single axis of motion and an array of sippers configured to match the vials contained within the reagent cartridge (e.g., number of sippers and/or volume of through liquid match number and/or volume of vials).

In some embodiments, the reagent cartridge is installed into a robotic manipulator with a single or limited number of sippers which are movable in X and Y directions, or is installed into a robotic manipulator with a plurality of sippers disposed in an array matching that of the reagent containers which is then actuated in a single axis only, engaging the reagent cartridge with the array of sippers which then provide fluidic connection to many reagents in a single motion.

In some embodiments, the reagent cartridge 3 and the temperature regulating device 10 are configured to be mounted together on a robotic manipulator. In some embodiments, robotic manipulator comprises an XY gantry with a z-stage. In some embodiments, the reagent cartridge 3 is configured to be mounted on a robotic sampling system on the z-stage, where the z-stage is the adaptor 4 to which the temperature regulating device 9 is attached. In some embodiments, the reagent cartridge 3 and the temperature regulating device 9 are configured to be mounted together on a robotic manipulator, and the heating or cooling of the reagents and/or samples occurs while the robotic sampling system is in use.

In some embodiments, the reagent cartridge is configured to be mounted below a robotic sampling system while attached to the temperature regulating device.

In some embodiments, the temperature regulating device 9 is mounted onto the z-stage of a robotic manipulator, which is a flat planar surface that physically moves up and down. The temperature regulating device may be mounted using flat head screws, but alternatively may be mounted with adhesive or other methods. In some embodiments, the temperature regulating device 9 is not removable from the z-stage by a user and is permanently fixed to the apparatus. In some preferred embodiments, the reagent cartridge 3 is a consumable/disposable item that is loaded onto the z-stage in a sliding motion (see FIG. 1C) and is secured onto the z-stage by positional features both on the reagent cartridge 3 and the z-stage. Specifically, the z-stage has rails that orient the cartridge in the x-direction and a ball-spring that orients the reagent cartridge 3 in the y-direction. In these preferred embodiments, the reagent cartridge 3 has a complementary set of rails that slide into the z-stage rails.

Advantages of the disclosed configuration of the reagent handling system 10 include built-in flexibility in accommodating various reagent/sample types and volumes by replacing reagent tray 1 of the reagent cartridge 3 with another reagent tray 1 having suitable receptacles 5 because the thermal transfer utilizes fluid rather than a solid temperature-controlled surface with a particular topography. In addition, the reagents and/or samples are readily available for use in the apparatus (for analysis) while being temperature stabilized by the fluid in the temperature-controlled volume. It is in contrast to traditional storage of reagents in a refrigerator or oven, which requires an extra step of transferring them out of the refrigerator or oven. It is also in contrast to an existing manner of reagent storage on an apparatus which may utilize a temperature-controlled plate (e.g., aluminum plate) that matches the topography of the bottom of the reagent tray, where the temperature-controlled plate would need to change if the size, shape, or quantity of reagents in the reagent tray were to change. In some embodiments, in a method of performing a peptide analysis, reagents and/or samples may need to be kept within a desired temperature range for an extended period of time, such as from 1 h to 48 h or more, and need to be taken out by the autosampler system at certain time points. In the disclosed configuration, the reagents are used/available for a peptide analysis while being temperature stabilized, and can be used for multiple samples over an extended period of time, allowing improved automation of the whole process.

In some embodiments, while performing peptide analysis, reagents and/or samples are kept within a desired temperature range inside the reagent cartridge 3 inserted in the apparatus for at least 1 h, 2 h, 3 h, 4 h, 5 h, 10 h, 15 h, 20 h, 24 h, 30 h, 48 h, 72 h, or longer period of time.

In some embodiments, the reagent cartridge 3 is configured to hold some of the reagents within the temperature-controlled volume and some of the reagents outside of the temperature-controlled volume.

In some embodiments, the reagent tray comprises a unique identifier (e.g., unique alphanumeric identifier or a barcode). In some embodiments, the reagent handling system further comprises a sensor means configured to be able to detect the unique identifier present on the reagent tray when the reagent tray is installed into the reagent cartridge.

In some embodiments, the reagent cartridge is uniquely identifiable via a barcode. This barcode may be a 1D or 2D printed barcode, or an RFID tag barcode. In these embodiments, the apparatus further comprises a complementary barcode scanner, such as a 1D or 2D visual barcode scanner or an RFID detector.

In some embodiments, a method for performing a macromolecule (e.g., peptide) analysis is disclosed, the method comprising the steps of:
(a) placing a plurality of reagents in a reagent tray 1;
(b) attaching a reagent cartridge 3 to a temperature regulating device 9 to form a temperature-controlled volume, wherein the reagent cartridge comprises the reagent tray 1 attached to a carrier 2, and the temperature regulating device 9 is configured to heat or cool the fluid within the temperature-controlled volume;
(c) powering the temperature regulating device 9 to provide the heated or cooled fluid to the temperature-controlled volume; and
(d) using reagents from the plurality of reagents to perform an analysis of macromolecules in a sample, while the reagents are kept within a desired temperature range by the provided fluid.

In some embodiments, a method for testing macromolecules is disclosed, the method comprising:
(a) placing a plurality of reagents in a reagent cartridge configured to hold the plurality of reagents;
(b) attaching the reagent cartridge to a temperature regulating device to form a temperature-controlled volume, wherein (i) an interior surface of the reagent cartridge and a surface of the temperature regulating device form boundaries of the temperature-controlled volume, and (ii) the temperature regulating device is configured to heat or cool a gaseous fluid that is at least partially contained within the temperature-controlled volume;
(c) powering the temperature regulating device to heat or cool the gaseous fluid within the temperature-controlled volume, thereby keeping reagents the plurality of reagents in the reagent cartridge within a desired temperature range; and
(d) testing macromolecules using reagents from the plurality of reagents, while the reagents are kept within the desired temperature range by the gaseous fluid for a desired period of time.

In some embodiments of the disclosed methods, step (b) of the disclosed methods is performed before step (a). In other embodiments, step (b) of the disclosed methods is performed after step (a).

In some embodiments of the disclosed methods, the fluid within the temperature-controlled volume is heated or cooled for a period of at least 1 hour and no longer than 72 hours. In some embodiments of the disclosed methods, the fluid within the temperature-controlled volume is maintained within the desired temperature range for a period of at least one hour and no longer than 72 hours.

In some embodiments of the disclosed methods and systems, the reagents comprise samples to be analyzed.

In some embodiments of the disclosed methods and systems, the temperature-controlled volume is essentially the same as a volume of the reagent cartridge formed by internal surfaces of the reagent tray and, optionally, carrier. The term “essentially the same volume” refers to a difference between two volumes of no more than 10%. The volume of the reagent cartridge refers to a volume of a gaseous liquid contained within of the reagent cartridge when the reagent cartridge is placed on a plain surface and

In some embodiments of the disclosed methods and systems, the temperature-controlled volume is no more than 20% larger, no more than 30% larger, no more than 40% larger, or no more than 50% larger than a volume of the reagent cartridge formed by internal surfaces of the reagent tray and, optionally, carrier.

In some embodiments of the disclosed methods and systems, the temperature-controlled volume is no more than 20% larger than a volume of the reagent cartridge formed by internal surfaces of the reagent tray and, optionally, carrier.

In some embodiments of the disclosed methods and systems, the reagent cartridge is attached on top of the temperature regulating device, and wherein an interior surface of the reagent cartridge forms side boundaries and an upper boundary of the temperature-controlled volume. In preferred embodiments, before the reagent cartridge is attached to the temperature regulating device, no temperature-controlled volume exists within the system.

In some embodiments of the disclosed methods and systems, the reagent cartridge is at least partially disposable (i.e., a part of the reagent cartridge, such as reagent tray is made of recyclable material, such as recyclable plastic).

In some embodiments of the disclosed methods and systems, an upper surface of the reagent cartridge has a plurality of protrusions extended downwardly into the temperature-controlled volume and configured to accommodate a plurality of vials or reagents. In some embodiments, the plurality of protrusions comprises cylindrical protrusions. In some embodiments of the disclosed methods and systems, the plurality of protrusions comprises at least two different pluralities of cylindrical protrusions, and each plurality of cylindrical protrusions configured to accommodate a different type of centrifuge vials.

In preferred embodiments of the disclosed methods and systems, the reagent cartridge is attached on top of the temperature regulating device, and wherein after the attachment of the reagent cartridge to the temperature regulating device, an interior surface of the reagent cartridge forms both side boundaries and an upper boundary of the temperature-controlled volume. In preferred embodiments, before the reagent cartridge is attached to the temperature regulating device, no temperature-controlled volume exists within the system.

In some embodiments, the reagent cartridge is attached on top of the temperature regulating device, and wherein a surface of the reagent tray forms the upper boundary of the temperature-controlled volume.

In some embodiments of the disclosed methods and systems, the surface of the reagent tray has a plurality of protrusions extended downwardly into the temperature-controlled volume and configured to accommodate a plurality of vials or reagents. In some embodiments, the plurality of protrusions comprises cylindrical protrusions. In some embodiments of the disclosed methods and systems, the plurality of protrusions comprises at least two different pluralities of cylindrical protrusions, and each plurality of cylindrical protrusions configured to accommodate a different type of centrifuge vials.

In some embodiments of the disclosed methods and systems, the reagent cartridge or the reagent tray comprises a horizontally planar floor and a plurality of reagent receptacles each comprising an access opening and a closed end, wherein each reagent receptacle of the plurality of reagent receptacles extends vertically downwardly into the temperature-controlled volume with an outer surface of the closed end located within the temperature-controlled volume, which allows for efficient temperature control of a reagent within the reagent receptacle, and wherein the floor comprising access openings of the reagent receptacles (see, e.g., FIG. 13).

In some embodiments, the closed end of any one of the reagent receptacles of the reagent cartridge or the reagent tray is not in direct contact with the surface of the temperature regulating device.

In some embodiments, closed ends of at least two different reagent receptacles of the reagent cartridge or the reagent tray are located at different distances from the surface of the temperature regulating device.

In some embodiments, the temperature-controlled volume of the reagent handling system is at least 5% greater and no more than 5 times greater than a total volume of the plurality of reagent receptacles of the reagent cartridge or the reagent tray.

In some embodiments, at least one reagent maintained within the desired temperature range in the system comprises a peptide or a protein. In some embodiments, at least one reagent receptacle contains an engineered peptidase. In some embodiments, at least one reagent receptacle contains a binding agent.

In some embodiments, an upper surface of the reagent cartridge has a plurality of protrusions extended downwardly into the temperature-controlled volume and configured to accommodate a plurality of vials or reagents.

In preferred embodiments of the disclosed methods and systems, there is a space filled with the gaseous fluid between closed ends of reagent receptacles and the surface of the temperature regulating device that faces the temperature-controlled volume and forms a boundary of the temperature-controlled volume. In other words, the reagent receptacles located within the reagent cartridge or the reagent tray are not in direct contact with the surface of the temperature regulating device that forms the boundary of the temperature-controlled volume. In some embodiments, the space between the closed end of any one of the reagent receptacles and the surface of the temperature regulating device is at least 1 millimeter (mm), at least 0.5 centimeter (cm), at least 1 cm, at least 2 cm, between 0.5 cm and 10 cm, or between 0.5 cm and 20 cm. In some embodiments, the fluid transmits energy between the temperature regulating device and the reagent receptacles of the reagent cartridge or the reagent tray, thereby controlling temperature of reagents present in the reagent receptacles. In preferred embodiments, one can accommodate a variety of different reagent receptacles within the reagent cartridge each having a different shape (i.e., geometry); accordingly, different reagents and/or samples placed in these reagent receptacles can be kept within desired temperature range(s) by the gaseous fluid for a desired period of time regardless of their size/volume.

When the temperature regulating device is powered on and running to heat or cool the gaseous fluid within the temperature-controlled volume, a thermal equilibrium is reached between the surface of the temperature regulating device and reagent receptacles of the reagent cartridge (or reagents in the reagent receptacles), which allows for keeping reagents in the reagent receptacles within desired temperature range(s). In some embodiments, the thermal equilibrium is reached in 10 min, 30 min, 1 h, or 2 h after the temperature regulating device is powered on and running. In some embodiments, after reaching the thermal equilibrium, the gaseous fluid trapped within the temperature-controlled volume of the reagent cartridge can act as an insulator protecting the desired temperature range(s) of the reagents in the reagent receptacles. In preferred embodiments, insulator-like properties of the gaseous fluid trapped within the temperature-controlled volume of the reagent cartridge helps to keep the reagents within the desired temperature range(s) for a desired period of time or as long as the temperature regulating device is running.

In some embodiments, different desired temperature ranges for different individual reagents within the same reagent cartridge may be achieved. This can be obtained to using a specific geometry for reagent receptacles configured to accommodate different individual reagents. For example, when the temperature regulating device provides cooling, reagent receptacles that are close to the surface of the temperature regulating device would be more affected by cooling, and may be configured to accommodate reagents having desired temperature range close to temperature near the surface of the temperature regulating device (a colder desired temperature range). Instead, other reagent receptacles that located far from the surface of the temperature regulating device (but still within the same cartridge) are less affected by cooling, and can accommodate reagents having a warmer desired temperature range.

In some embodiments of the disclosed methods and systems, closed ends of at least two different reagent receptacles of the reagent cartridge or the reagent tray are located at different distances from the surface of the temperature regulating device.

In some embodiments of the disclosed methods and systems, the reagent tray 1 is made of recyclable plastic.

In some embodiments of the disclosed methods and systems, the reagent cartridge 3 is configured to hold some of the reagents within the temperature-controlled volume and some of the reagents outside of the temperature-controlled volume.

In some embodiments of the disclosed methods and systems, the reagent cartridge 3 is mounted below a robotic sampling system while attached to the temperature regulating device 9, and the robotic sampling system aspirates and dispenses the reagents to perform the analysis of peptides.

In some embodiments of the disclosed methods and systems, after placing the plurality of reagents in the reagent tray 1, reagents of the plurality of reagents are sealed within reagent receptacles, and the reagent tray 1 is attached to the carrier 2. In some embodiments, the interface between components of the reagent tray 1, carrier 2, and/or reagent cartridge 3 may be tamper-evident and may be inspectable by a camera system to verify integrity of the tamper-evident interface.

In some embodiments of the disclosed methods and systems, the plurality of reagents comprise binding agents conjugated with nucleic acid coding tags.

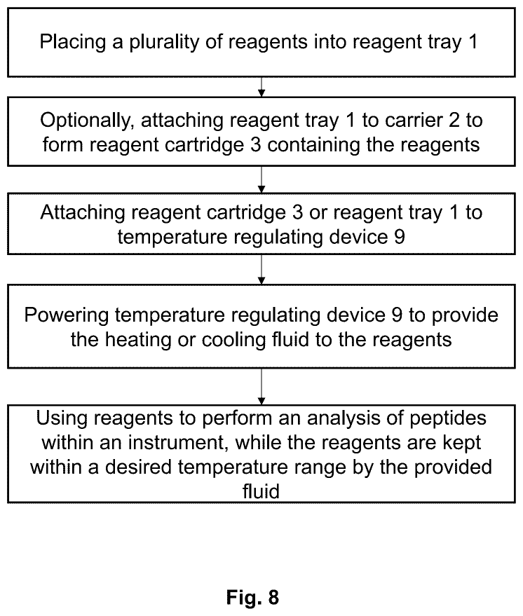

FIG. 8 illustrates an exemplary workflow of the method for performing a peptide analysis. Peptide samples to be analyzed can be handled in the same way as reagents used during the peptide analysis. Reagent cartridge 3 containing reagents and/or samples is connected to temperature regulating device 9 and configured to heat or cool fluid present in the temperature-controlled volume formed by interior surface of the reagent cartridge 3. During the peptide analysis, reagents and/or samples in the reagent cartridge 3 are kept at the desired temperature(s).

In preferred embodiments of the method of performing a peptide analysis, reagents and/or samples are kept within a desired temperature range for an extended period of time, such as from 1 h to 48 h, and are taken out by an autosampler or robotic system at certain time points. In the disclosed configurations, the reagents are used or available to be used for a peptide analysis while being temperature stabilized, and can be used for multiple samples over an extended period of time, allowing improved automation of the whole process.

In some embodiments, a reagent cartridge 3 is provided, comprising:
a reagent tray 1 configured to hold a plurality of reagents and/or samples; and a carrier 2, wherein the reagent tray 1 and the carrier 2 form a temperature-controlled volume configured to at least partially confine a fluid, and the reagent cartridge 3 is configured to be attached to a temperature regulating device configured to cool or heat the fluid.

In some embodiments, a kit for performing a peptide analysis is provided, the kit comprising:
(a) a plurality of reagents and/or samples for performing a peptide analysis in a reagent tray 1 configured to hold the plurality of reagents and/or samples; and
(b) a carrier 2, wherein: i) the reagent tray 1 is configured to be inserted into the carrier 2 to form a reagent cartridge 3; ii) the reagent cartridge 3 is configured to be attached to a temperature regulating device 9; iii) the reagent cartridge 3 attached to the temperature regulating device 9 form a temperature-controlled volume configured to at least partially confine a fluid; and iv) the temperature regulating device 9 is configured to cool or heat the fluid.

In some embodiments, the testing of macromolecules is performed in an apparatus, and the reagent cartridge attached to the temperature regulating device is inserted into, or otherwise connected to the apparatus. In these embodiments, reagents of the plurality of reagents kept in the reagent cartridge within the desired temperature range are transferred into the apparatus as needed in a specific time and/or in a particular step of the testing process. In some embodiments, an array of sippers configured to match the reagent receptacles of the reagent cartridge are used to transfer reagents from the reagent cartridge to the apparatus. Other means, either automated or manual (such as pipetting) can also be used to transfer reagents from the reagent cartridge to the apparatus as needed during the testing process.

In some embodiments, reagents and/or samples for performing an analysis (such as peptide analysis. or other analysis) on an apparatus are delivered to a user inside the reagent tray 1 or inside the reagent cartridge 3. The reagents and/or samples may be sealed inside receptacles of the reagent tray 1 to allow safe delivery of the pre-filled reagent tray 1 and to avoid contamination, spill over or other issues. In other embodiments, reagents and/or samples for performing an analysis may be placed into the reagent tray 1 by a user.

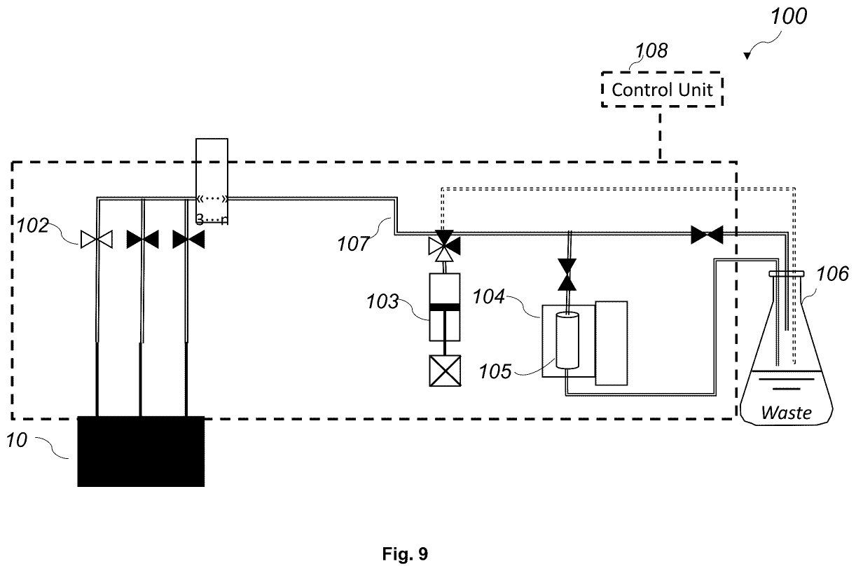

FIG. 9 illustrates an exemplary apparatus 100 for analyzing macromolecules (e.g., peptides). The system includes n number of channels for supplying reagents into the reaction chamber 105, each connected to controlled valves 102 which may be opened or closed for the delivery of various reagents via each of the channels from the reagent handling system 10 comprising the reagent tray 1 filled with the reagents. The reagent handling system 10 is not a part of the apparatus 100. In some embodiments, the reagent handling system 10 is portable and can be attached to (or otherwise connected to) the apparatus 100 when a treatment of a sample containing macromolecules is started. Reagents and/or samples may be inserted into the reagent handling system 10 before or after the reagent handling system 10 is attached to the apparatus 100.

Reagents inside the reagent handling system 10 are maintained within a desired temperature range. The reagent handling system 10 is fluidically connected by n channels to a pump 103. Selected reagents can be delivered from the reagent handling system 10 to the reaction chamber 105 by opening of controlled valve(s) 102 through a series of fluidic connections 107. The reaction chamber is contained in a temperature-controlled unit 104. The reagents may include wash buffers, peptides, nucleic acids, peptide-nucleic acid conjugates, binding agents, enzymes, chemical or enzymatic reagents for cleaving a terminal amino acid residue of peptides, and/or reagents for a ligation or polymerase-mediated reaction.

In some embodiments, provided herein is an apparatus for preparing or treating macromolecules (e.g., peptides, polypeptides, and proteins), which are immobilized, directly or indirectly via a linker, on a support. In some embodiments, the macromolecules for treatment using the apparatus are polypeptides or peptides immobilized on a porous support. In some embodiments, the apparatus is used to carry out one or more steps of a macromolecule analysis assay (e.g., a polypeptide analysis assay), such as any of the steps of the methods described herein, in an automated manner. The macromolecules analysis assay may include a cyclic process for treating the sample, wherein the process includes various repeated steps. In some cases, the macromolecule analysis assay comprises nucleic acid encoding of molecule recognition events. In some cases, the provided apparatus is for use in treating, preparing, and/or modifying a macromolecule from a sample for sequencing and/or other analysis that employs barcoding. In some cases, the use of the apparatus for the treatment and/or preparation of the macromolecules enables downstream analysis of the sequence of single individual peptides, polypeptides, or proteins. The apparatus and automated treatment may be used to treat a plurality of samples simultaneously. In an exemplary workflow for analysis of the polypeptide analytes, a large collection of polypeptides (e.g., 50 million-1 billion) or more can be immobilized on one or more supports and analyzed using the automated methods and/or apparatus provided herein. In some embodiments, the apparatus is configured to integrate performing any combinations of the following: enzymatic reaction, an aqueous-phase biochemical reaction, and/or an organic reaction. In some embodiments, an apparatus automated treatment of a sample containing macromolecules in a high-throughput manner is used as disclosed in WO 2021/076648 A1 and in the U.S. application Ser. No. 17/769,321 filed on Apr. 14, 2022, incorporated herein by reference.

In some embodiments, the apparatus can be used to deliver sample(s) or be loaded with sample(s) in an automated manner. The sample can be prepared for analysis appropriately before loading on to the apparatus, including digestion, chemical treatments, attachment of a protein sample with DNA tags to generate a peptide-DNA chimera, etc., and can be stored in the reagent cartridge of the reagent handling system within a desired temperature range. In some embodiments, one or more sample is provided to the apparatus and loaded by the apparatus to the reaction chamber in an automated fashion. The reaction chamber may comprise a support for attaching the sample. In some embodiments, the apparatus may be designed and equipped with mechanics and features for automated sample loading, such as for mechanical engagement with the sample-providing cartridge. In some such cases, the sample-providing cartridge can be provided to the apparatus in the same or a different location than the reagent cartridge. In some cases, the automated processes may include delivery of various reagents to the samples and performing washes. In some embodiments, appropriate control programs can be used with the provided apparatus.

In some embodiments, one or more components of the apparatus is controlled by a control unit. For example, FIG. 9 depicts a control unit 108. In some cases, the control unit also receives feedback from various components of the apparatus. In some embodiments, the control unit is in communication with one or more valves, one or more pumps, temperature-controlled unit(s), and/or one or more reaction chambers. In some embodiments, the control unit is used to automate and/or control the temperature of the reaction chamber(s). In some embodiments, the control unit is used to automate and/or control the flow of liquids in the apparatus, (e.g., presence and absence of flow, position of a valve, direction of flow and/or flowrate, etc.). In some embodiments, the control unit is used to automate and/or control the positioning of the valve(s) 102 (see FIG. 9). In some cases, the control unit is used to automate and/or control and/or delivery of said one or more reagent(s) to said sample container(s) via control of a pump 103.

In some embodiments, the apparatus includes a plurality of valves connected in a supply line having an upstream end and a downstream end, wherein at least one or each of said valves is positionable to provide alternate flow paths therethrough. In some embodiments, the reagent receptacles of the reagent cartridge are fluidically connected to the reaction chamber. In some cases, the fluidic connection between the reagent receptacles and reaction chamber is continuous. In some cases, the fluidic connection between the reagent receptacles and reaction chamber is discontinuous or not completely continuous. In some embodiments, a closed system is formed from the reagent receptacles to the reaction chamber. In some cases, the system is closed from input (e.g., from the reagent cartridge) to waste. In some embodiments, one supply line connects a single reagent receptacle to a single reaction chamber. In some cases, one supply line connects multiple reagent receptacles to the reaction chamber.

In some embodiments, the reaction chamber 105 comprises a cartridge comprising a filter means or a frit for retaining the sample while allowing flow-through of other materials (e.g., buffers) into a waste container 106. In some embodiments, the sample comprises macromolecules (e.g., peptides) joined to a solid support. A control unit 108 controls various components of the apparatus 100 including for example, the valve(s) and pump with respect to the dispensing and flow of the reagents. In some embodiments, the control unit also receives feedback from various components of the system including one or more of the valves 102, the temperature-controlled unit 104, and/or the reaction chamber(s) 105. In some embodiments, the components that are controlled or in communication with the control unit are shown or illustrated with the dashed box and all the electronic components would be in connection with the control unit.

Provided herein is also a method for testing macromolecules using the apparatus disclosed above, the method comprising:
(a) placing a plurality of reagents in a reagent cartridge of the reagent handling system disclosed above and configured to hold the plurality of reagents;
(b) attaching the reagent cartridge to a temperature regulating device of the reagent handling system to form temperature-controlled volume;
(c) powering the temperature regulating device to heat or cool a gaseous fluid within the temperature-controlled volume, thereby keeping reagents the plurality of reagents in the reagent cartridge within a desired temperature range; and
(d) delivering macromolecules and reagents from the plurality of reagents to the reaction chamber of the apparatus disclosed above, while the reagents are kept within the desired temperature range by the gaseous fluid for a desired period of time;
(e) testing macromolecules in the reaction chamber using the reagents delivered in step (d).

In some embodiments, step (b) of the method is performed before step (a). In other embodiments, step (b) of the method is performed after step (a).

In some embodiments, a plurality of reagents provided in a reagent handling system 10 or a reagent tray 1 comprises one or more binding agents, wherein each binding agent is conjugated to a detectable label or to a nucleic acid coding tag. In some embodiments, each binding agent comprises a polypeptide or an aptamer. In some embodiments, the plurality of reagents comprises 2, 3, 5, 10, 15, 20, 25 or more binding agents, wherein each binding agent is attached to a detectable label or to a nucleic acid coding tag that comprises identifying information regarding binding agent. In some embodiments, each binding agent binds to one or more labeled terminal amino acid residues of peptide analytes. In some embodiments, binding agents bind specifically or selectively to one or more labeled terminal amino acid residues of peptide analytes. In some embodiments, binding agents bind specifically or selectively to certain components or epitopes of peptide analytes. In some embodiments, each binding agent comprises an antibody or an aptamer. In some embodiments, each binding agent comprises an engineered protein configured to recognize specifically or selectively certain components or epitopes of peptide analytes.

In some embodiments, a plurality of reagents provided in a reagent handling system 10 or a reagent tray 1 also comprises one or more modifier agents capable of labeling terminal amino acid residues of peptide analytes, and generating labeled terminal amino acid residues of peptide analytes to which binding agent can bind.

In some embodiments, a plurality of reagents provided in a reagent handling system 10 or a reagent tray 1 also comprises one or more cleavage reagents configured to cleave labeled terminal amino acid residues from peptide analytes. In some embodiments, the one or more cleavage reagents include reagents disclosed in published patent application WO 2020/223133 A1.

In some embodiments, a plurality of reagents provided in a reagent handling system 10 or a reagent tray 1 also comprises one or more engineered dipeptidyl peptidases configured to cleave labeled terminal amino acid residues from peptide analytes. In some embodiments, the one or more engineered dipeptidyl peptidases include engineered proteins disclosed in published patent application US 2021/0214701 A1.

In some embodiments, while performing macromolecule analysis, reagents and/or samples are kept within a desired temperature range inside the reagent cartridge 3 inserted in the apparatus for at least 1 h, 2 h, 3 h, 4 h, 5 h, 10 h, 15 h, 20 h, 24 h, 30 h, 48 h, 72 h, or longer period of time.

In some embodiments, desired temperature ranges include, without limitation, −20° C.-0° C.; 0° C.-5° C.; 0° C.-10° C.; 5° C.-15° C. and 0° C.-15° C. Other temperature ranges may be implemented as well by choosing appropriate work regimes of temperature regulating device 9.

In some embodiments, peptides to be analyzed (peptide analytes) are immobilized on a solid support.

Various reactions may be used to attach the peptide analytes to a support (e.g., a solid or a porous support). The peptide analytes may be attached directly or indirectly to the support. In some cases, the peptide analytes are attached to the support via a nucleic acid. Exemplary reactions include click chemistry reactions, such as the copper catalyzed reaction of an azide and alkyne to form a triazole (Huisgen 1, 3-dipolar cycloaddition), strain-promoted azide alkyne cycloaddition (SPAAC), reaction of a diene and dienophile (Diels-Alder), strain-promoted alkyne-nitrone cycloaddition, reaction of a strained alkene with an azide, tetrazine or tetrazole, alkene and azide [3+2] cycloaddition, alkene and tetrazine inverse electron demand Diels-Alder (IEDDA) reaction (e.g., m-tetrazine (mTet) or phenyl tetrazine (pTet) and trans-cyclooctene (TCO); or pTet and an alkene), alkene and tetrazole photoreaction, Staudinger ligation of azides and phosphines, and various displacement reactions, such as displacement of a leaving group by nucleophilic attack on an electrophilic atom (Horisawa 2014, Knall, Hollauf et al. 2014). Exemplary displacement reactions include reaction of an amine with: an activated ester; an N-hydroxysuccinimide ester; an isocyanate; an isothioscyanate, an aldehyde, an epoxide, or the like. In some embodiments, iEDDA click chemistry is used for immobilizing peptides to a support since it is rapid and delivers high yields at low input concentrations. In another embodiment, m-tetrazine rather than tetrazine is used in an iEDDA click chemistry reaction, as m-tetrazine has improved bond stability. In another embodiment, phenyl tetrazine (pTet) is used in an iEDDA click chemistry reaction. In one case, a peptide is labeled with a bifunctional click chemistry reagent, such as alkyne-NHS ester (acetylene-PEG-NHS ester) reagent or alkyne-benzophenone to generate an alkyne-labeled peptide. In some embodiments, an alkyne can also be a strained alkyne, such as cyclooctynes including Dibenzocyclooctyl (DBCO).

The methods disclosed herein can be used for analysis, including detection, quantitation and/or sequencing, of a plurality of macromolecules simultaneously (multiplexing). Multiplexing as used herein refers to analysis of a plurality of macromolecules (e.g. peptides) in the same assay. The plurality of macromolecules can be derived from the same sample or different samples. The plurality of macromolecules can be derived from the same subject or different subjects. The plurality of macromolecules that are analyzed can be different macromolecules, or the same macromolecule derived from different samples. A plurality of macromolecules includes 2 or more macromolecules, 10 or more macromolecules, 50 or more macromolecules, 100 or more macromolecules, 1,000 or more macromolecules, 5,000 or more macromolecules, 10,000 or more macromolecules, 100,000 or more macromolecules, or 1,000,000 or more macromolecules.

### EXEMPLARY EMBODIMENTS

Among the provided embodiments are:

1. A reagent handling system configured to maintain reagents within a desired temperature range, the reagent handling system comprising a temperature regulating device and a reagent cartridge configured to hold a plurality of reagents and configured to be attached to the temperature regulating device, wherein a temperature-controlled volume is formed upon attachment of the reagent cartridge to the temperature regulating device, and an interior surface of the reagent cartridge and a surface of the temperature regulating device form boundaries of the temperature-controlled volume contained within the reagent handling system; and wherein the temperature regulating device is configured to cool or heat a gaseous fluid that is at least partially confined within the temperature-controlled volume, and further configured to maintain the gaseous fluid confined in the temperature-controlled volume within the desired temperature range.

2. The system of embodiment 1, wherein the temperature-controlled volume is not formed until the reagent cartridge is attached to the temperature regulating device.

3. The system of embodiment 1 or embodiment 2, wherein the reagent cartridge comprises:
(i) a reagent tray configured to hold a plurality of reagents; and
(ii) a carrier, wherein the reagent tray and the carrier form the temperature-controlled volume that confine the gaseous fluid.

4. The system of embodiment 3, wherein surfaces of both the reagent tray and the carrier form the temperature-controlled volume.

5. The system of any one of embodiments 3-4, wherein the reagent tray is one of a plurality of alternative reagent trays configured to be attached to the carrier to form the temperature-controlled volume.

6. The system of any one of embodiments 3-5, wherein the reagent tray is configured to accommodate vials including the reagents, and the vials extend into the temperature-controlled volume.

7. The system of any one of embodiments 3-6, wherein the reagent cartridge is configured to hold more than one type of reagent trays.

8. The system of any one of embodiments 5-7, wherein at least two reagent trays of the plurality of alternative reagent trays have different arrangements of reagent receptacles.

9. The system of any one of embodiments 3-8, wherein a top of the temperature-controlled volume is defined by the reagent tray and optionally sides of the temperature-controlled volume are defined by the carrier.

10. The system of any one of embodiments 1-9, wherein the gaseous fluid is atmospheric air.

11. The system of any one of embodiments 1-10, wherein the temperature regulating device comprises a thermoelectric cooler.

12. The system of any one of embodiments 1-11, wherein the reagent cartridge is configured to be attached to the temperature regulating device via an adaptor.

13. The system of any one of embodiments 1-12, wherein the temperature regulating device comprises a heatsink and a fan configured to circulate the gaseous fluid within the temperature-controlled volume.

14. The system of any one of embodiments 1-13, wherein the reagent cartridge or the reagent tray is made of recyclable plastic.

15. The system of any one of embodiments 1-14, wherein the reagent cartridge and the temperature regulating device are configured to be mounted together on a robotic manipulator.

16. The system of any one of embodiments 1-15, wherein the reagent cartridge is configured to be mounted below a robotic sampling system while attached to the temperature regulating device.

17. The system of any one of embodiments 1-16, wherein the reagents comprise samples to be analyzed.

18. The system of any one of embodiments 1-17, wherein the reagent cartridge is configured to hold some of the reagents within the temperature-controlled volume and some of the reagents outside of the temperature-controlled volume.

19. The system of any one of embodiments 3-18, wherein the reagent tray comprises a unique identifier, and wherein the reagent handling system further comprises a sensor means configured to be able to detect the unique identifier present on the reagent tray when the reagent tray is installed into the reagent cartridge

20. The system of any one of embodiments 1-19, wherein the reagent cartridge is attached on top of the temperature regulating device, and wherein after the attachment of the reagent cartridge to the temperature regulating device, an interior surface of the reagent cartridge forms both side boundaries and an upper boundary of the temperature-controlled volume.

21. The system of any one of embodiments 1-20, wherein an upper surface of the reagent cartridge has a plurality of protrusions extended downwardly into the temperature-controlled volume and configured to accommodate a plurality of vials or reagents.

22. The system of embodiment 21, wherein the plurality of protrusions comprises cylindrical protrusions.

23. The system of embodiment 22, wherein the plurality of protrusions comprises at least two different pluralities of cylindrical protrusions, and each plurality of cylindrical protrusions configured to accommodate a different type of centrifuge vials.

24. The system of any one of embodiments 3-20, wherein the surface of the reagent tray has a plurality of protrusions extended downwardly into the temperature-controlled volume and configured to accommodate a plurality of vials or reagents.

25. The system of any one of embodiments 1-20, wherein the reagent cartridge or the reagent tray comprises a plurality of reagent receptacles each comprising an access opening and a closed end.

26. The system of embodiment 25, wherein each reagent receptacle of the plurality of reagent receptacles extends vertically downwardly into the temperature-controlled volume with an outer surface of the closed end located within the temperature-controlled volume, thereby allowing for temperature control of a reagent within the reagent receptacle.

27. The system of embodiment 25, wherein there is a space filled with the gaseous fluid between the closed end of any one of the reagent receptacles and the surface of the temperature regulating device, and wherein the space is 1 millimeter or more.

28. The system of embodiment 25, wherein the closed end of any one of the reagent receptacles of the reagent cartridge or the reagent tray is not in direct contact with the surface of the temperature regulating device.

29. The system of embodiment 25, wherein closed ends of at least two different reagent receptacles of the reagent cartridge or the reagent tray are located at different distances from the surface of the temperature regulating device.

30. The system of any one of embodiments 25-29, wherein the temperature-controlled volume of the reagent handling system is at least 5% greater and no more than 5 times greater than a total volume of the plurality of reagent receptacles of the reagent cartridge or the reagent tray.

31. The system of any one of embodiments 1-30, wherein at least one reagent maintained within the desired temperature range in the system comprises a peptide or a protein.

32. The system of any one of embodiments 1-31, wherein the desired temperature range is different from a temperature outside the reagent cartridge by at least 5° C.

33. A method for testing macromolecules, the method comprising the steps of:
(a) placing a plurality of reagents in a reagent cartridge configured to hold the plurality of reagents;
(b) attaching the reagent cartridge to a temperature regulating device to form a temperature-controlled volume, wherein (i) an interior surface of the reagent cartridge and a surface of the temperature regulating device form boundaries of the temperature-controlled volume, and (ii) the temperature regulating device is configured to heat or cool a gaseous fluid that is at least partially contained within the temperature-controlled volume;
(c) powering the temperature regulating device to heat or cool the gaseous fluid within the temperature-controlled volume, thereby keeping reagents the plurality of reagents in the reagent cartridge within a desired temperature range; and
(d) testing macromolecules using reagents from the plurality of reagents, while the reagents are kept within the desired temperature range by the gaseous fluid for a desired period of time.

34. The method of embodiment 33, wherein the desired temperature range is different from a temperature outside the reagent cartridge by at least 5° C.

35. The method of embodiment 33 or embodiment 34, wherein step (b) is performed before step (a).

36. The method of any one of embodiments 33-35, wherein the fluid within the temperature-controlled volume is maintained within the desired temperature range for a period of at least one hour and no longer than 72 hours.

37. The method of any one of embodiments 33-36, wherein the reagents comprise samples to be analyzed.

38. The method of any one of embodiments 33-37, wherein the reagent tray is made of recyclable plastic.

39. The method of any one of embodiments 33-38, wherein the reagent cartridge is configured to hold some of the reagents within the temperature-controlled volume and some of the reagents outside of the temperature-controlled volume.

40. The method of any one of embodiments 33-39, wherein the reagent cartridge is mounted below a robotic sampling system while attached to the temperature regulating device, and the robotic sampling system dispenses the reagents to perform the testing of macromolecules.

41. The method of any one of embodiments 33-40, wherein after placing the plurality of reagents in the reagent tray, the plurality of reagents are sealed and the reagent tray is attached to the carrier.

42. The method of any one of embodiments 33-41, wherein the plurality of reagents comprises one or more binding agents, wherein each binding agent is conjugated to a detectable label or to a nucleic acid coding tag.

43. The method of any one of embodiments 33-42, wherein each macromolecule to be tested comprises a polypeptide.

44. The method of any one of embodiments 33-43, wherein the temperature-controlled volume is not formed until the reagent cartridge is attached to the temperature regulating device.

45. The method any one of embodiments 33-44, wherein the reagent cartridge comprises:
(i) a reagent tray configured to hold a plurality of reagents; and
(ii) a carrier, wherein the reagent tray and the carrier form the temperature-controlled volume that confine the gaseous fluid.

46. The method of embodiment 45, wherein surfaces of both the reagent tray and the carrier form the temperature-controlled volume.

47. The method of any one of embodiments 45-46, wherein the reagent tray is one of a plurality of alternative reagent trays configured to be attached to the carrier to form the temperature-controlled volume.

48. The method of any one of embodiments 33-47, wherein an upper surface of the reagent cartridge has a plurality of protrusions extended downwardly into the temperature-controlled volume and configured to accommodate a plurality of vials or reagents.

49. The method of embodiment 48, wherein the plurality of protrusions comprises at least two different pluralities of cylindrical protrusions, and each plurality of cylindrical protrusions configured to accommodate a different type of centrifuge vials.

50. The method of any one of embodiments 45-49, wherein the surface of the reagent tray has a plurality of protrusions extended downwardly into the temperature-controlled volume and configured to accommodate a plurality of vials or reagents.

51. The method of any one of embodiments 33-50, wherein the reagent cartridge or the reagent tray comprises a plurality of reagent receptacles each comprising an access opening and a closed end.

52. The method of embodiment 51, wherein each reagent receptacle of the plurality of reagent receptacles extends vertically downwardly into the temperature-controlled volume with an outer surface of the closed end located within the temperature-controlled volume, thereby allowing for temperature control of a reagent within the reagent receptacle.

53. The method of embodiment 51 or embodiment 52, wherein there is a space filled with the gaseous fluid between the closed end of any one of the reagent receptacles and the surface of the temperature regulating device, and wherein the space is 1 millimeter or more.

54. The method of any one of embodiments 51-53, wherein the closed end of any one of the reagent receptacles of the reagent cartridge or the reagent tray is not in direct contact with the surface of the temperature regulating device.

55. The method of any one of embodiments 51-54, wherein closed ends of at least two different reagent receptacles of the reagent cartridge or the reagent tray are located at different distances from the surface of the temperature regulating device.

56. The method of any one of embodiments 51-55, wherein the temperature-controlled volume is at least 5% greater and no more than 5 times greater than a total volume of the plurality of reagent receptacles of the reagent cartridge or the reagent tray.

57. The method of any one of embodiments 33-56, wherein at least one reagent maintained within the desired temperature range comprises a peptide or a protein.

58. A method for testing macromolecules using the reagent handling system of embodiment 1, the method comprising:
(a) placing a plurality of reagents in a reagent cartridge of the reagent handling system configured to hold the plurality of reagents;
(b) attaching the reagent cartridge to a temperature regulating device of the reagent handling system to form temperature-controlled volume;
(c) powering the temperature regulating device to heat or cool a gaseous fluid within the temperature-controlled volume, thereby keeping reagents the plurality of reagents in the reagent cartridge within a desired temperature range; and
(d) testing macromolecules using reagents from the plurality of reagents, while the reagents are kept within the desired temperature range by the gaseous fluid for a desired period of time.

59. A kit for performing testing of macromolecules, the kit comprising:
(a) a plurality of reagents in a reagent tray configured to hold the plurality of reagents, wherein reagents of the plurality of reagents are configured for delivery to an apparatus for testing of macromolecules; and
(b) a carrier, wherein: i) the reagent tray is configured to be inserted into the carrier to form a reagent cartridge; ii) the reagent cartridge is configured to be attached to a temperature regulating device; iii) the reagent cartridge attached to the temperature regulating device form a temperature-controlled volume configured to at least partially confine a gaseous fluid, wherein an interior surface of the reagent cartridge and a surface of the temperature regulating device form boundaries of the temperature-controlled volume; and iv) the temperature regulating device is configured to cool or heat the gaseous fluid confined in the temperature-controlled volume, and further configured to maintain the gaseous fluid confined in the temperature-controlled volume within a desired temperature range.

60. An apparatus for automated treatment of a sample containing macromolecules, which apparatus comprises:
at least one non-planar reaction chamber with a volume equal to or less than about 20 ml, wherein the at least one reaction chamber is subjected to temperature control and configured for allowing fluid flow-through;
a reagent handling system comprising a reagent cartridge comprising a plurality of reagent receptacles for containing a plurality of reagents, wherein the reagent handling system is configured to maintain the plurality of reagents within a desired temperature range, wherein the reagent handling system further comprises a temperature regulating device attached to the reagent cartridge, wherein a temperature-controlled volume is formed upon attachment of the temperature regulating device to the reagent cartridge, and an interior surface of the reagent cartridge and a surface of the temperature regulating device form boundaries of the temperature-controlled volume contained within the reagent handling system; and wherein the temperature regulating device is configured to cool or heat a gaseous fluid that is at least partially confined within the temperature-controlled volume, and further configured to maintain the gaseous fluid confined in the temperature-controlled volume within the desired temperature range;
a plurality of valves connected in a supply line having an upstream end and a downstream end; and
a control unit to control delivery of reagents of the plurality of reagents to the at least one reaction chamber, wherein:
delivery of the reagents is individually addressable,
the supply line connects the reagent receptacles to the at least one reaction chamber and the reagent receptacles are fluidically connected to the at least one reaction chamber, and
temperature control of the at least one reaction chamber, temperature control of the temperature-controlled volume, positioning of valves of the plurality of valves, and/or delivery of the reagents to the at least one reaction chamber is automated and controlled by the control unit

61. A reagent cartridge comprising:
a reagent tray configured to hold a plurality of reagents; and
a carrier, wherein the reagent tray and the carrier form a temperature-controlled volume configured to at least partially confine a fluid, and the reagent cartridge is configured to be attached to a temperature regulating device configured to cool or heat the fluid present within the temperature-controlled volume.

62. A kit for performing a macromolecule analysis, the kit comprising:
(a) a plurality of reagents for performing a macromolecule analysis in a reagent tray configured to hold the plurality of reagents; and
(b) a carrier, wherein: i) the reagent tray is configured to be inserted into the carrier to form a reagent cartridge; ii) the reagent cartridge is configured to be attached to a temperature regulating device; iii) the reagent cartridge attached to the temperature regulating device form a temperature-controlled volume configured to at least partially confine a fluid; and iv) the temperature regulating device is configured to cool or heat the fluid present within the temperature-controlled volume.

63. A method for testing macromolecules using the apparatus of embodiment 60, the method comprising:
(a) placing a plurality of reagents in a reagent cartridge of the reagent handling system of embodiment 1 configured to hold the plurality of reagents;
(b) attaching the reagent cartridge to a temperature regulating device of the reagent handling system to form temperature-controlled volume;
(c) powering the temperature regulating device to heat or cool a gaseous fluid within the temperature-controlled volume, thereby keeping reagents the plurality of reagents in the reagent cartridge within a desired temperature range; and
(d) delivering macromolecules and reagents from the plurality of reagents to the reaction chamber of the apparatus of embodiment 60, while the reagents are kept within the desired temperature range by the gaseous fluid for a desired period of time;
(e) testing macromolecules in the reaction chamber using the reagents delivered in step (d).

64. The method of embodiment 63, wherein step (b) is performed before step (a).

65. The method of embodiment 63, wherein step (a) is performed before step (b).

66. A reagent handling system configured to maintain reagents within a desired temperature range, the reagent handling system comprising:
a reagent cartridge configured to hold a plurality of reagents and comprising a circulation volume formed within the reagent cartridge by interior surfaces of the reagent cartridge; and
a temperature regulating device configured to cool or heat a fluid that is at least partially contained within the circulation volume, and further configured to maintain the fluid contained in the circulation volume within the desired temperature range.

### Examples

The following examples are offered to illustrate but not to limit the methods, compositions, and uses provided herein. Certain aspects of the present invention, including, but not limited to, embodiments for high throughput macromolecule analysis and sequencing (the Proteocode™ peptide analysis assay) and related methods were disclosed in earlier published application US20190145982 A1, US20200348308 A1, U.S. Pat. No. 20200348307 A1, US20210214701 A1, U.S. Pat. No. 11,169,157 B1, the contents of which are incorporated herein by reference in its entirety.

Example 1. Design and performance of exemplary reagent handling system 10.

Exemplary reagent cartridge 3 having both reagent tray 1 and carrier 2 has been constructed using a 3D printer. The carrier 2 of the reagent cartridge 3 (FIG. 1B) was configured to accommodate reagent tray 1 (FIG. 1A) and contained a 127.76 mm×85.48 mm cutout with a rim at the bottom of the cutout (FIG. 1B). The height of cutout within the carrier 2 was 68.00 mm, measured from the base of the carrier 2 to the top of the inner wall of the cutout. The carrier 2 also contained an area with receptacles for reagents that do not require cooling during the analysis. The reagent tray 1 was a 127.76 mm×85.48 mm insert containing receptacles for reagents that require cooling during the analysis. The reagent tray 1 was designed to be placed into the cutout of the carrier 2 forming the reagent cartridge 3 (FIG. 1C). Other reagent trays 1 having the same geometry and dimensions, but different tube layouts or types of receptacles 5 can also be used with the same carrier 2.

The temperature regulating device 9 of the reagent handling system 10 includes a TEC stack (FIG. 6A and FIG. 6B) that was composed of the following components:
1. TEC: CUI Devices, P/N CPM-2F (Qmax=43 W, ATmax (Th=50° C.)=73° C.);
2. Heat Sink, Cold: Advanced Thermal Solutions, P/N ATS-FPX054054013-17-C1-R0;
3. Heat Sink, Hot: Advanced Thermal Solutions, P/N ATS-FPX070070020-29-C1-R0;
4. Fan, Cold side: Orion Fans, P/N OD4010-05HB55; the fan has the following characteristics: Speed=800 RPM, Max Airflow=9.2 CFM, Max Static Pressure=0.20″ H2O, Rating=IP55;
5. Fan, Hot side: CUI Devices, P/N CFM-7020V-232-330-20; the fan has the following characteristics: Speed=3200 RPM, Max Airflow=29 CFM, Max Static Pressure=0.140″ H2O;

6. Adapter: 3D printed from polylactic acid (PLA) and attached to a ¼ inch thick aluminum plate.

The TEC control board used in this Example is the Meerstetter TEC-1091 Model. The temperature probe used on the cold side is a PT1000 Resistance Temperature Detector (RTD) and the temperature probe on the hot side is a Negative Temperature Coefficient (NTC) Thermistor with 10 kiloOhms resistance.

Testing of the reagent handling system 10 was performed as follows. The system was tested using a reagent cartridge containing tubes filled with deionized water. The reagent tray 1 shown in FIG. 1A accommodates 5 mL Eppendorf tubes (left receptacles) and 1.1 mL Micronic tubes (the remaining receptacles). PT1000 probes were submerged in each tube containing deionized water to measure temperature. Specifically, the 5 mL Eppendorf tubes contained 4 milliLiters of deionized water, and the 1.1 mL Micronic tubes contained 800 microLiters of deionized water.

The reagent cartridge 3 with the tubes was inserted into the adaptor 4 and positioned over the TEC stack (see FIG. 6). In this Example, cooling of the “reagents” in the tubes were performed for 90 minutes using a Proportional-Integral-Derivative (PID) mechanism for temperature control with the following parameters: TEC Max Current=2.8 A; PID Control Values: P=25, I=30, D=7. The target temperature was set to 0.0° C., and the TEC control board supplied a current and voltage to the TEC to cool the cold side temperature to 0.0° C.

The following information was recorded once per minute:
a) TEC Object Temperature; b) TEC Sink Temperature; c) TEC Voltage; d) TEC Current;
e) Water temperature for three water-filled tubes.

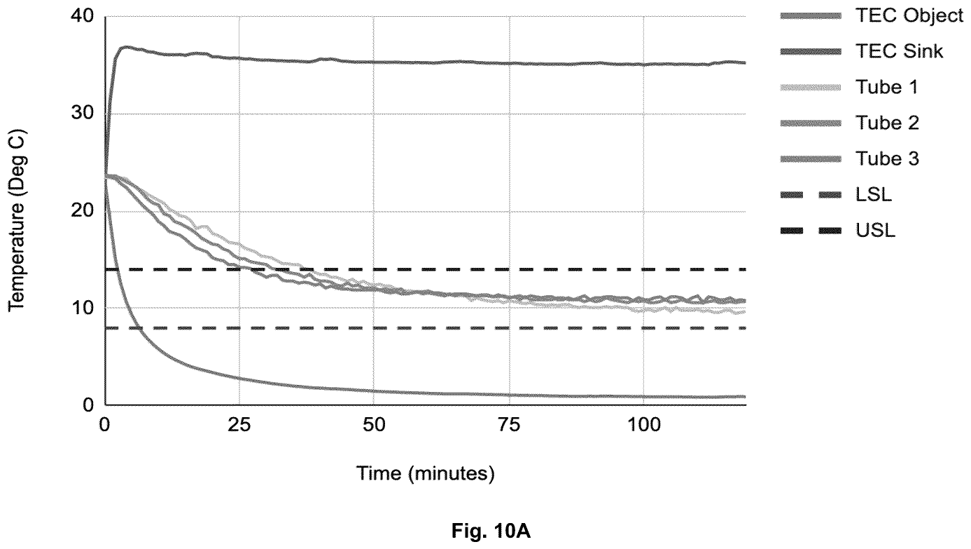

FIGS. 10A and 10B contain the data plotted over time. The water temperatures within each of the tubes were able to reach steady state temperatures in the range 8.0-14.0° C. The lowest temperature reached was 9.5° C. in the 5 mL Eppendorf tube. The TEC parameters and setpoint can be adjusted to target the desired temperature ranges.

This design may be optimized to lower the tube temperatures closer to the TEC object temperature by improving heat transfer efficiency on the cold side of the TEC stack.

The present disclosure is not intended to be limited in scope to the particular disclosed embodiments, which are provided, for example, to illustrate various aspects of the invention. Various modifications to the compositions and methods described will become apparent from the description and teachings herein. Such variations may be practiced without departing from the true scope and spirit of the disclosure and are intended to fall within the scope of the present disclosure. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A reagent handling system configured to maintain reagents within a desired temperature range, the reagent handling system comprising a temperature regulating device and a reagent cartridge configured to hold a plurality of reagents and configured to be attached to the temperature regulating device, wherein a temperature-controlled volume is formed upon attachment of the reagent cartridge to the temperature regulating device, and an interior surface of the reagent cartridge and a surface of the temperature regulating device form boundaries of the temperature-controlled volume contained within the reagent handling system; and wherein the temperature regulating device is configured to cool or heat a gaseous fluid that is at least partially confined within the temperature-controlled volume, and further configured to maintain the gaseous fluid confined in the temperature-controlled volume within the desired temperature range.

2. The system of claim 1, wherein the reagent cartridge comprises:
(i) a reagent tray configured to hold a plurality of reagents; and
(ii) a carrier, wherein the reagent tray and the carrier form the temperature-controlled volume that confine the gaseous fluid.

3. The system of claim 2, wherein the reagent tray is one of a plurality of alternative reagent trays configured to be attached to the carrier to form the temperature-controlled volume.

4. The system of claim 3, wherein at least two reagent trays of the plurality of alternative reagent trays have different arrangements of reagent receptacles.

5. The system of claim 1, wherein the temperature regulating device comprises a fan configured to circulate the gaseous fluid within the temperature-controlled volume.

6. The system of claim 1, wherein the reagent cartridge is configured to hold some of the reagents within the temperature-controlled volume and some of the reagents outside of the temperature-controlled volume.

7. The system of claim 2, wherein the reagent tray comprises a unique identifier, and wherein the reagent handling system further comprises a sensor means configured to be able to detect the unique identifier present on the reagent tray when the reagent tray is installed into the reagent cartridge.

8. The system of claim 1, wherein an upper surface of the reagent cartridge has a plurality of protrusions extended downwardly into the temperature-controlled volume and configured to accommodate a plurality of vials or reagents.

9. The system of claim 8, wherein the plurality of protrusions comprises at least two different pluralities of cylindrical protrusions, and each plurality of cylindrical protrusions configured to accommodate a different type of vials.

10. The system of claim 1, wherein the reagent cartridge or the reagent tray comprises a plurality of reagent receptacles each comprising an access opening and a closed end.

11. The system of claim 10, wherein each reagent receptacle of the plurality of reagent receptacles extends vertically downwardly into the temperature-controlled volume with an outer surface of the closed end located within the temperature-controlled volume, thereby allowing for temperature control of a reagent within the reagent receptacle.

12. The system of claim 10, wherein there is a space filled with the gaseous fluid between the closed end of any one of the reagent receptacles and the surface of the temperature regulating device, and wherein the space is 1 millimeter or more.

13. The system of claim 10, wherein the closed end of any one of the reagent receptacles of the reagent cartridge or the reagent tray is not in direct contact with the surface of the temperature regulating device.

14. The system of claim 10, wherein closed ends of at least two different reagent receptacles of the reagent cartridge or the reagent tray are located at different distances from the surface of the temperature regulating device.

15. The system of claim 1, wherein at least one reagent maintained within the desired temperature range in the system comprises a polypeptide or a protein.

16. The system of claim 1, wherein the desired temperature range is different from a temperature outside the reagent cartridge by at least 5° C.

17. A method for testing macromolecules, the method comprising the steps of:
(a) placing a plurality of reagents in a reagent cartridge configured to hold the plurality of reagents;
(b) attaching the reagent cartridge to a temperature regulating device to form a temperature-controlled volume, wherein (i) an interior surface of the reagent cartridge and a surface of the temperature regulating device form boundaries of the temperature-controlled volume, and (ii) the temperature regulating device is configured to heat or cool a gaseous fluid that is at least partially contained within the temperature-controlled volume;
(c) powering the temperature regulating device to heat or cool the gaseous fluid within the temperature-controlled volume, thereby keeping reagents from the plurality of reagents in the reagent cartridge within a desired temperature range; and
(d) testing macromolecules using the reagents from the plurality of reagents, while the reagents are kept within the desired temperature range by the gaseous fluid for a desired period of time.

18. The method of claim 17, wherein step (b) is performed before step (a).

19. The method of claim 17, wherein the fluid within the temperature-controlled volume is maintained within the desired temperature range for a period of at least one hour and no longer than 72 hours.

20. The method of claim 17, wherein the plurality of reagents comprises one or more binding agents, wherein each binding agent is conjugated to a detectable label or to a nucleic acid coding tag.

21. The method of claim 17, wherein each macromolecule to be tested comprises a polypeptide.

22. The method of claim 17, wherein at least one reagent maintained within the desired temperature range comprises a polypeptide or a protein.

23. A kit for performing testing of macromolecules, the kit comprising:
(a) a plurality of reagents in a reagent tray configured to hold the plurality of reagents, wherein reagents of the plurality of reagents are configured for delivery to an apparatus for testing of macromolecules; and
(b) a carrier, wherein: i) the reagent tray is configured to be inserted into the carrier to form a reagent cartridge; ii) the reagent cartridge is configured to be attached to a temperature regulating device; iii) the reagent cartridge attached to the temperature regulating device forms a temperature-controlled volume configured to at least partially confine a gaseous fluid, wherein an interior surface of the reagent cartridge and a surface of the temperature regulating device form boundaries of the temperature-controlled volume; and iv) the temperature regulating device is configured to cool or heat the gaseous fluid confined in the temperature-controlled volume, and further configured to maintain the gaseous fluid confined in the temperature-controlled volume within a desired temperature range.

24. An apparatus for automated treatment of a sample containing macromolecules, the apparatus comprises:
a non-planar reaction chamber with a volume equal to or less than about 20 ml, wherein the reaction chamber is subjected to temperature control and configured for allowing fluid flow-through;
a reagent handling system comprising a reagent cartridge comprising a plurality of reagent receptacles for containing a plurality of reagents, wherein the reagent handling system is configured to maintain the plurality of reagents within a desired temperature range, wherein the reagent handling system further comprises a temperature regulating device attached to the reagent cartridge, wherein a temperature-controlled volume is formed upon attachment of the temperature regulating device to the reagent cartridge, and an interior surface of the reagent cartridge and a surface of the temperature regulating device form boundaries of the temperature-controlled volume contained within the reagent handling system; and wherein the temperature regulating device is configured to cool or heat a gaseous fluid that is at least partially confined within the temperature-controlled volume, and further configured to maintain the gaseous fluid confined in the temperature-controlled volume within the desired temperature range;
a plurality of valves connected in a supply line; and
a control unit to control delivery of reagents of the plurality of reagents to the reaction chamber, wherein:
the delivery of the reagents is individually addressable,
the reagent receptacles are fluidically connected to the reaction chamber via the supply line, and
temperature control of the reaction chamber, temperature control of the temperature-controlled volume, positioning of valves of the plurality of valves, and/or delivery of the reagents to the reaction chamber is automated and controlled by the control unit.
